(19) United States
(12) Patent Application Publication
(10) Pub. No.: US 2013/0295143 A1
(43) Pub. Date: Nov. 7, 2013

(54) ELECTROPROCESSING OF ACTIVE PHARMACEUTICAL INGREDIENTS

(71) Applicant: Massachusetts Institute of Technology, Cambridge, MA (US)

(72) Inventors: Bernhardt Levy Trout, Lexington, MA (US); Blair Kathryn Brettmann, Cambridge, MA (US); Allan Stuart Myerson, Boston, MA (US)

(21) Appl. No.: 13/832,812

(22) Filed: Mar. 15, 2013

Related U.S. Application Data
(60) Provisional application No. 61/641,719, filed on May 2, 2012.

(51) Int. Cl. A61J 3/00

(52) U.S. Cl. CPC A61J 3/00
USPC 424/400; 264/465; 514/395; 514/370

(57) ABSTRACT

Electrospinning of crystalline particles comprising active pharmaceutical ingredients (API) from suspensions yields fibrous compositions comprising the API. The morphology and size of the crystalline particles may be preserved. The particles may be predominantly retained by fibers and distributed throughout the fibrous mesh. Tablet forms of the APIs prepared from the fibrous compositions demonstrate higher dissolution rates than tablets prepared from compacted powders of the APIs.

### RELATED APPLICATIONS

This application claims the benefit of U.S. provisional application Ser. No. 61/641,719 titled “Electroprocessing of Active Pharmaceutical Ingredients,” filed on May 2, 2012, which is incorporated herein by reference in its entirety for all purposes.

### BACKGROUND

Electrospinning is a process by which thin polymeric fibers may be formed. Electrospinning has been used for various applications since 1902, when Morton first patented an apparatus for electrospinning. (See, Morton, W. J. 1902. Method of Dispersing Fluids. U.S. Pat. No. 705,691) Electrospinning may be used to produce fibrous microstructures by extruding and drying a polymer solution to yield fibers with diameters ranging from the tens of nanometers to about ten microns. Since Morton's time, many materials have been fabricated using electrospinning, including pharmaceutical formulations, superhydrophobic surfaces, catalysis supports, filters, and tissue engineering scaffolds.

In one embodiment of an electrospinning apparatus 100, e.g., as depicted in FIG. 1, a solution 120 containing a polymer may be extruded under high electric fields from a small orifice 112 at the tip of a needle or device 110 containing the solution. An electric potential 130 may be applied between the device and/or solution and a collection substrate 150. The electric potential 130 can create high electric fields in the vicinity of the orifice that draws the solution 120 from a drop at the orifice to produce a thin liquid jet stream 140. At the drop, electrostatic forces are in equilibrium with the surface tension, and the drop takes on a conical form, known as the Taylor cone. The jet stream can be emitted from the cone under the influence of the electric field. As the stream propagates toward the collection substrate 150, solvent in the stream that carries the polymer may evaporate to yield at least one thin polymeric fiber 145. Fibers formed in this way may be collected at the collection plate 150.

### SUMMARY

The present application is directed towards methods and apparatus useful for forming polymeric fibers that retain crystalline particles of a pharmaceutically active ingredient. It has been discovered that drug-laden fibers may be produced using embodiments of electrospinning processes, and that the particles and their original crystalline structure may be preserved during the process. Further, the crystalline particles may be significantly larger than the size of the fiber retaining the particles. Compositions of matter comprising the drug-laden fibers are also described.

According to one embodiment, a composition of matter comprises a plurality of elongated polymeric fibers and a plurality of crystals comprising at least one pharmaceutically active ingredient. At least a portion of the crystals may be retained by one or more of the elongated polymeric fibers, and at least some of the crystals that are retained have a first cross-sectional dimension that is greater than a second cross-sectional dimension of the fiber.

In some embodiments, the polymeric fibers may be biocompatible, and in some cases, the polymeric fibers may be biodegradable. The composition may be in the form of a porous non-woven matrix. In some implementations, at least a portion of the crystals may be dispersed within the non-woven matrix. Some of the dispersed crystals may be present as aggregates, and some of the retained crystals may be present as aggregates. In some embodiments, the crystals in the fibrous composition may be substantially of a same polymorph, or there may be a plurality of polymorphs present. The polymorph(s) present in the fibrous composition may be substantially the same polymorph(s) present in the suspension prior to electrospinning.

Crystals that are retained by fibers may be encapsulated by a thin film of polymer. The thin film of polymer may be the same polymer used to form the elongated polymeric fibers. According to some embodiments, a first cross-sectional dimension of the crystalline particles may be at least about 2 times a second cross-sectional dimension of the electrospun fibers, though in other embodiments, the first cross-section dimension may be less than twice the diameter of the fibers, and in some cases less than the diameter of the fibers. The diameters of the fibers may range in sizes up to about 10 microns. The first cross-sectional dimension of the crystalline particles may be an average cross-sectional dimension or a maximum cross-sectional dimension. The second cross-sectional dimension of the fibers may be an average cross-sectional dimension or a maximum cross-sectional dimension.

In some embodiments, the fibrous composition may be formed into a tablet or capsule for pharmaceutical application. In some implementations, the fibrous composition may be formed into a pad or patch for pharmaceutical application.

In some embodiments, a method for producing a fibrous composition in which crystalline particles of active pharmaceutical ingredients are retained comprises providing a suspension comprising a carrier liquid, a polymeric binder dissolved in the carrier liquid, and a crystalline pharmaceutically active ingredient suspended in the carrier liquid. The method may further include exposing the suspension to an electric field to produce at least one elongated fiber comprising at least a portion of the polymeric binder and at least some of the crystalline pharmaceutically active ingredient. The act of exposing the suspension to an electric field may comprise subjecting the suspension to an electrospinning step.

In some embodiments, the polymeric binder may biodegradable, and in other implementations, the polymeric binder may be biocompatible. According to some embodiments, the electrospinning is free-surface electrospinning. The electrospinning may be arranged to produce the at least one elongated fiber to have a characteristic preselected first cross-sectional dimension. The first cross-sectional dimension may be less than a second cross-sectional dimension associated with the crystalline pharmaceutically active ingredient. The second cross-sectional dimension may be an average cross-sectional dimension or maximum cross-sectional dimension associated with crystalline particles of the crystalline pharmaceutically active ingredient.

The method for producing a fibrous composition may further comprise forming the elongated fibers comprising at least a portion of the polymeric binder and at least some of the crystalline pharmaceutically active ingredient into a porous non-woven matrix. According to some embodiments, the method may further comprise forming the non-woven matrix into a tablet, capsule, pad or a patch for pharmaceutical application.

In some implementations, a method for producing a fibrous composition in which crystalline particles of active pharmaceutical ingredients are retained comprises exposing a suspension comprising organic crystalline particles dispersed in a solution to an electric field such that at least one fiber retaining one or more of the organic crystalline particles is drawn from the suspension.

In various embodiments, the organic crystalline particles comprise a pharmaceutically active ingredient. The polymorphism of the organic crystalline particles retained by the at least one fiber may be the same as the polymorphism of the organic crystalline particles in the suspension. In some embodiments, the organic crystalline particles may be characterized by a first cross-sectional dimension that is greater than a second cross-sectional dimension of the at least one fiber. In some implementations, the organic crystalline particles may be characterized by a first cross-sectional dimension that is equal to or less than a second cross-sectional dimension of the at least one fiber. The organic crystalline particles that are retained in the fiber may be at least partially encapsulated by a polymer.

According to some embodiments, the method for producing a fibrous composition may further comprise applying an electric potential between a deposition substrate and a conductor in contact with the suspension. The conductor may be a needle used to deliver a droplet of the suspension or a rotating wire that moves through the suspension. The electric potential may be between about 10 kV and about 40 kV. The method may further comprise forming a porous non-woven matrix comprising the at least one fiber at the deposition substrate.

In some implementations, the method for producing a fibrous composition may further comprise forming the non-woven matrix into a tablet, capsule, pad, or a patch for pharmaceutical application. In some embodiments, the method may additionally comprise providing a polymeric binder dissolved in a carrier liquid as the solution. The polymeric binder may be biocompatible in some embodiments. The polymeric binder may be biodegradable in some embodiments.

In various aspects, the method may comprise selecting a carrier liquid such that the polymeric binder is soluble in the carrier liquid and the organic crystalline particles are insoluble or weakly soluble in the carrier liquid. The method may further comprise dispersing the organic crystalline particles in the solution.

The foregoing and other aspects, embodiments, and features of the present teachings can be more fully understood from the following description in conjunction with the accompanying drawings.

### BRIEF DESCRIPTION OF THE DRAWINGS

The skilled artisan will understand that the figures, described herein, are for illustration purposes only. It is to be understood that in some instances various aspects of the invention may be shown exaggerated or enlarged to facilitate an understanding of the invention. In the drawings, like reference characters generally refer to like features, functionally similar and/or structurally similar elements throughout the various figures. The drawings are not necessarily to scale, emphasis instead being placed upon illustrating the principles of the teachings. The drawings are not intended to limit the scope of the present teachings in any way.

FIG. 1 depicts an embodiment of an electrospinning apparatus;

FIGS. 2A-2B depict embodiments of apparatus for free-surface electrospinning;

FIG. 3 illustrates formation of a jet stream including particles from a wire, according to one embodiment;

FIG. 4 shows images of droplet formation on a wire and evolution of a jet stream from the droplet, according to one embodiment;

FIG. 5 depicts one embodiment of a method for producing fibrous compositions comprising pharmaceutical ingredients;

FIG. 6 plots experimental results of particle loading in fibrous compositions;

FIGS. 7A-7D are scanning electron micrographs showing polystyrene microspheres retained by electrospun fibers, in which particle size is varied;

FIGS. 8A-8C are scanning electron micrographs showing polystyrene microspheres retained by electrospun fibers, in which particle loading is varied;

FIGS. 9A-9B are scanning electron micrographs showing polystyrene microspheres retained by electrospun fibers, and shows particle aggregation and high loading;

FIG. 10 is a theoretical plot of particle velocity in the jet stream as a function of particle size, a negative velocity would indicate that the particle would not be retained in the jet stream;

FIG. 11 is a scanning electron micrograph showing a lead (Pb) particle retained by a fiber, according to one embodiment;

FIGS. 12A-12C show measured particle size distributions for 4.3 wt % ABZ crystals suspended in 8.6 wt % PVP in ethanol under various conditions;

FIGS. 13A-13C show measured particle size distributions for 4.3 wt % FAM crystals suspended in 8.6 wt % PVP in ethanol under various conditions;

FIG. 14A is a scanning electron micrograph showing an agglomeration of ABZ crystals in a sample as received;

FIG. 14B is a scanning electron micrograph showing FAM crystals in a sample as received;

FIG. 15A and FIG. 15C are scanning electron micrographs showing crystalline ABZ particles retained by electrospun fibers, according to one embodiment;

FIG. 15B and FIG. 15D are scanning electron micrographs showing crystalline FAM particles retained by electrospun fibers, according to one embodiment;

FIG. 16A are plots comparing differential scanning calorimetry measurements for ABZ in crystalline form, as received, and from electrospun fibrous compositions, according to one embodiment;

FIG. 16B are plots comparing differential scanning calorimetry measurements for FAM in crystalline form, as received, and from electrospun fibrous compositions, according to one embodiment;

FIG. 17A are plots comparing x-ray diffraction simulated spectra and measurements for ABZ in crystalline form and from electrospun fibrous compositions, according to one embodiment;

FIG. 17B are plots comparing x-ray diffraction simulated spectra and measurements for ABZ in crystalline form and from electrospun fibrous compositions, according to one embodiment; and

FIGS. 18A and 18B show results of dissolution measurements for samples of crystalline API produced from fibrous compositions according to some embodiments, and from compacted powder forms of the API.

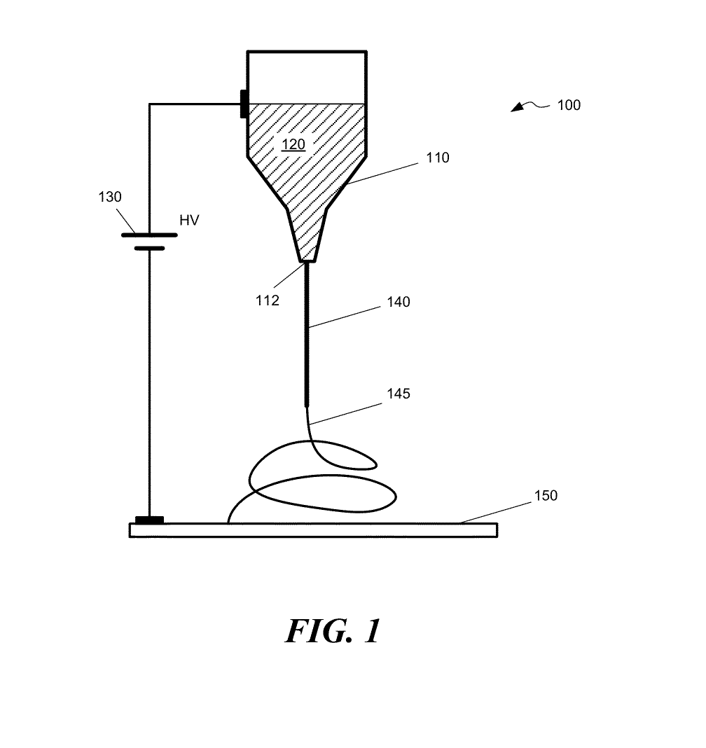

The features and advantages of the present invention will become more apparent from the detailed description set forth below when taken in conjunction with the drawings.

### DETAILED DESCRIPTION

Described herein are methods and apparatus that may be used to manufacture fibrous structures that retain pharmaceutically active ingredients. The fibrous structures can be made of biocompatible materials such as, for example, polymers. In some embodiments, the active pharmaceutical ingredients (APIs) are crystalline and their morphology is preserved throughout the manufacturing process. The fibrous structures may improve dissolution of the pharmaceutically active ingredients and thereby increase the pharmaceutical effectiveness or bioavailability of the active ingredients. The techniques and apparatus may be used for batch processing or continuous processing of pharmaceuticals.

The pharmaceutical industry relies primarily on batch processing of pharmaceuticals rather than continuous processing. In part, batch processing is used currently due to regulatory requirements and quality control challenges. Pharmaceutical production can require a significant amount of downstream processing steps that occur after a particular purified sample of an API has been prepared. The downstream steps might include any combination of costly drying, granulation, blending, milling, forming, and coating steps, which may be carried out prior to producing a marketable product. In consideration of these factors, certain embodiments involve the use of electrospinning techniques as methods for continuous processing of pharmaceuticals, and more particularly for producing fibrous compositions that retain crystalline particles of APIs. Further, certain embodiments relate to the use of free-surface electrospinning techniques for producing pharmaceutical compositions from a suspension containing pharmaceutically active ingredients, including crystalline pharmaceutically active ingredients. In certain embodiments, the crystalline APIs within the suspension can retain their crystal properties throughout the electrodeposition process. Accordingly, in some such embodiments, the crystals within the finally-formed electrodeposited material are in substantially the same form as they were within the suspension from which the film was formed.

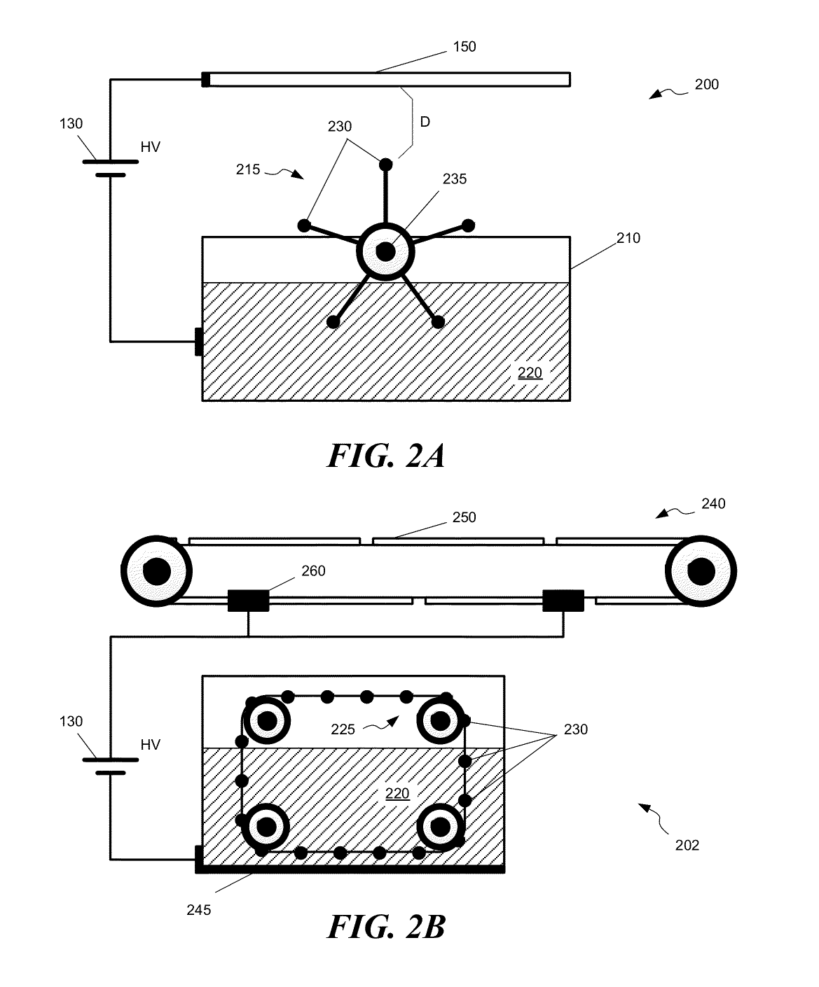

Electrospinning may be used for the continuous processing of pharmaceuticals as follows. In an exemplary electrospinning process, one or more active pharmaceutical ingredient(s) (along with any optional desired excipients) may be entrained in polymeric fibers that are formed directly from a fluid containing the API(s), excipient(s), and polymer. A highly volatile carrier liquid may be used to dissolve the polymer(s) and suspend the API(s). Because of the high surface area generated during electrospinning, the evaporation rate of the carrier liquid can be high, allowing for more efficient drying at ambient temperatures than might be observed with other pharmaceutical preparation techniques, e.g., thin film casting. In addition, no heat is necessary to blend ingredients during electrospinning, as they may already be well blended in the solution prior to electrospinning. In some embodiments, electrospinning is more suitable for downstream processing of heat-sensitive APIs than other pharmaceutical preparation techniques, e.g., melt extrusion. Embodiments of exemplary electrospinning apparatus are depicted in FIGS. 2A-2B.

Referring now to FIG. 2A, one embodiment of an apparatus for free-surface electrospinning is shown in elevation view. In overview, the free-surface electrospinning apparatus 200 may include a container 210, a rotating wire assembly 215, a deposition substrate 150, and a high voltage supply 130. The container 210 may be configured to contain a suspension 220 for electrospinning. The rotating wire assembly 215 may include one or more wires or rods 230 (viewed end on in the drawing) supported by a rotating shaft 235 and configured to rotate through the suspension 220, similar to the motion of a paddle wheel. The rods 230 have a length extending into the page of the drawing, and may be electrically conductive in some embodiments. In some implementations, the rods 230 may be made of electrically insulating material. The deposition substrate 150 may be electrically conductive and configured to attach to an electric potential, e.g., high voltage supply 130 or a ground potential.

In various embodiments, the system is arranged to establish an electric potential difference between the suspension 220 and/or wires 230 and the deposition substrate 150. For example, in one embodiment, the high voltage supply 130 may be connected between the deposition substrate 150 and rotating wire assembly 215, such that wires 230 are at a first electric potential and the deposition substrate 150 is at a second electric potential. The difference between the first and second electric potentials may be any selected value between about 5 kilovolts (kV) and about 50 kV. In some embodiments, the different between the first and second electric potentials may be any selected value between about 10 kV and about 40 kV. Positive or negative polarities may be used. In some implementations, the electric potential difference may be lower than 5 kV, and in other implementations the electric potential difference may be greater than 50 kV. For example, if the deposition substrate 150 is brought closer to the wires 230, then the voltage may be lowered.

The rotating wire assembly 215 may be rotated at a selected rate. The selected rate may be any value between about 1 revolution per minute (RPM) and about 60 RPM. According to some embodiments, the rate is between about 5 RMP and about 20 RPM. The deposition substrate 150 may be located a selected distance D from a nearest point of the rotating wire assembly. The selected distance may be any value between about 5 centimeters and about 1 meter. According to some embodiments, the distance D is between about 10 cm and about 50 cm. Although the deposition substrate is shown as a planar structure in FIG. 2A, it may be curved in some embodiments. For example, the deposition substrate may be shaped as a portion of a cylindrical shell that is spaced an approximately equal distance from the wires 230 of the rotating wire assembly 215.

FIG. 2B depicts an embodiment of a free-surface electrospinning apparatus which utilizes a rod conveyor mechanism 225 for sample production and handling. Instead of a rotating wire assembly, rods 230 may be disposed on a conveyor mechanism that moves the rods 230 through the suspension 220. In some embodiments, electrically conductive deposition pads 250 may be disposed on a sample conveyor mechanism 240. The deposition pads may be conveyed to a sample collection region over the suspension and biased to an electric potential via one or more brush contacts 260. After collecting a selected amount of electrospun fibrous composition, a deposition pad may be conveyed to a sample removal region where the electric potential is removed from the electrically conductive deposition pad 250.

According to some embodiments, the rods 230 and rotating assembly 215 or conveying assembly 225 may be made from insulating material. A large electrically conductive film 245 may be placed under the container 210, e.g., as shown in FIG. 2B. In such an embodiment, the electric field created by the high voltage supply 130 may be more uniform throughout the sample-production region and thereby improve the uniformity of electrospun fibers.

In some embodiments, the suspension 220 may be agitated. Agitation may be implemented using mechanical stirring methods. Additionally or alternatively, agitation may be implemented by applying ultrasonic acoustic energy (e.g., at a frequency in excess of 20 kHz such as, for example, between about 20 kHz and about 40 kHz) to the suspension. In some embodiments, acoustic energy with frequencies lower than 20 kHz may be used, and in some embodiments, acoustic energy with frequencies higher than 40 kHz may be used. According to some embodiments, agitation may be implemented by modulating the acoustic frequency between one or more values, as well as modulating the acoustic energy on and off for intervals of time. In some implementations, the rotating wire assembly 215 or the rod conveying mechanism may include sample-stirring features, e.g., fins, blades, porous sheets (not shown in the drawing), that aid in agitating the suspension 220.

Though the free-surface electrospinning apparatus of FIGS. 2A-2B are depicted with wires or rods 230, other elements may be used. In some embodiments, a drum may be used. In other embodiments, a cylindrical mesh may be used. In yet other embodiments, bubblers may be placed in the suspension to form gaseous bubbles at the surface of the suspension 220. The bubbles may, for example, provide surfaces to initiate electrospinning

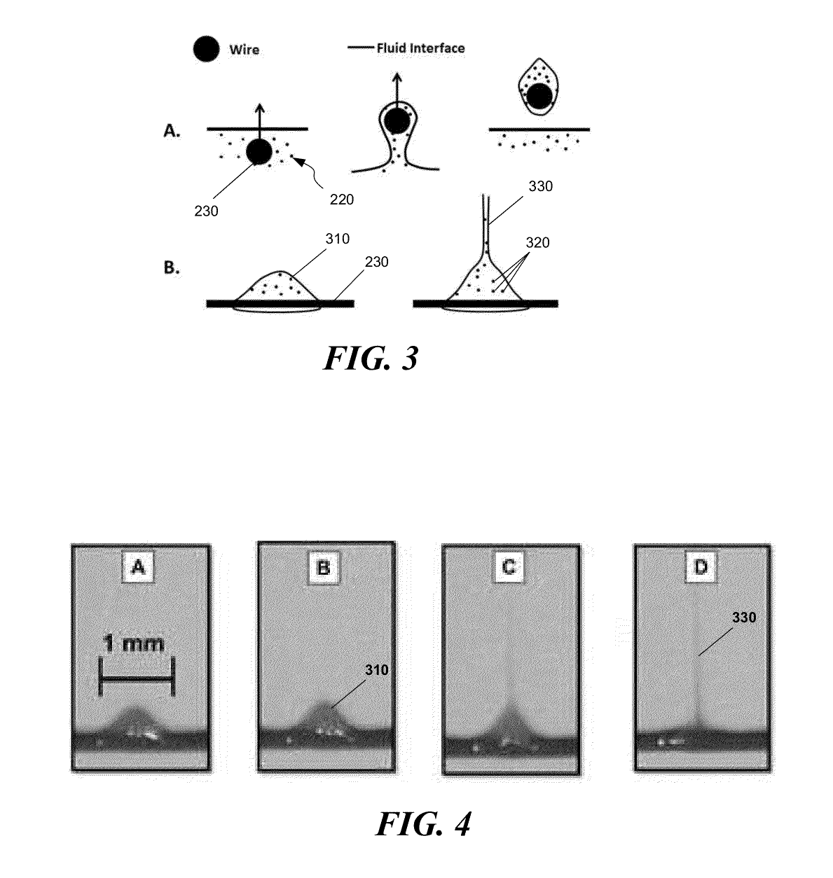

In the exemplary electrospinning operations illustrated in FIGS. 2A-2B, the wires or rods 230 rotate through the suspension and are wetted by the suspension. As they exit the suspension, they draw out a thin film of the fluid suspension. As illustrated in FIGS. 3A-3B, the film then breaks into droplets 310 due to Plateau-Rayleigh instabilities and, when a sufficient electric field is present, the droplets form into a Taylor cone. A jet stream 330 of the suspension is then emitted towards the collection plate forming a fibrous composition. The electrospinning continues until the fluid in the droplet is depleted, or the droplet rotates out of the range of sufficient electric field. The droplet formation process is depicted in FIGS. 3A-3B, and is also shown in the recorded images of FIGS. 4A-4B. FIG. 3A depicts the formation of the droplet as would be viewed from an end of the rod 230. FIG. 3B depicts the formation of a jet stream as would be viewed from a side of the rod. Multiple droplets and streams may form on a single rod and thereby increase the production rate of fibrous material as compared to a single needle. In a system that uses bubblers below the surface of the suspension 220, Taylor cones and jet streams may form at the surface of the bubbles. The production rate of fibrous material for free-surface electrospinning can be more than 10 times higher than the production rate for electrospinning using a single needle.

As can be envisioned from the drawing of FIGS. 3A-3B particles 320 within the suspension 220 may be drawn into the jet stream 330. Depending on a particle's size, the particle may be entrained in the fluid within jet stream 330 such that the particle may accompany the polymer or other components within jet stream 330 as they travel toward the substrate, such as deposition substrate 150 in FIG. 2A or deposition pad 250 in FIG. 2B. In some embodiments, this can result in the formation of a fiber (e.g., a polymeric fiber) as described above and deposition of a fibrous composition on the substrate. In addition, the particle(s) that was transported within jet stream 330 to the substrate can be retained in a fiber on the substrate. Particles that are said to be retained by a polymeric fiber can be at least partially or fully encapsulated by polymer of the fiber, so that a retained particle is attached to a fiber. In some embodiments, a particle that is retained by a fiber may be fully encapsulated by the polymer used to form the fiber. For example, there may be a film of the polymer surrounding the particle and connecting the particle to the fiber. In some embodiments, a particle that is retained by a fiber may be partially encapsulated by a polymer used to form the fiber. According to some embodiments, a particle may be retained at any location along a fiber, and in some embodiments a particle may be retained near an end of a fiber. In a fibrous composition produced from electrospinning of a suspension, there may be fully encapsulated particles and partially encapsulated particles that are retained by the fibers. Additionally, the fibrous composition may include particles dispersed in the composition that are not retained by a fiber, e.g., they are dispersed within a non-woven mesh of the fibrous composition but are not connected to a fiber. These dispersed particles may be fully encapsulated by the polymer, partially encapsulated by the polymer, or not encapsulated by the polymer.

As may be envisioned, during the electrospinning process fibrous structures accumulate at the deposition substrate 150 to form a non-woven mesh or matrix (not shown in the drawings). The mesh may be porous, and may be characterized by an average pore size. The porosity of the matrix may be controlled by one or more electrospinning parameters, e.g., applied voltage, rotation rate of the rotating assembly 215, and/or viscosity of the suspension 220.

In some electrospinning embodiments, fibers 145 having diameters in a range between about 20 nanometers (nm) and about 3000 nm may be produced from a fluid comprising a polymer, a carrier liquid capable of dissolving the polymer (and in which the API may be insoluble or only slightly soluble), and any desired additives. In other embodiments, larger fibers may be produced. The diameter of the fiber may be influenced by several electrospinning factors that include, but are not limited to, viscosity of the carrier liquid and/or the suspension formed using the carrier liquid, applied voltage, distance to the deposition substrate, and carrier liquid evaporation rate. The cross-sectional dimension or diameter of a fiber may vary along its length ranging from a maximum value to a minimum value. A fiber may be characterized by an average diameter. In a collection of fibers produced by electrospinning, there may be a distribution of the average diameters of the fibers centered about a mean value for the ensemble. The 2-sigma distribution of average fiber diameters may be greater than ±50% of the mean value in some embodiments, less than ±50% of the mean value in some embodiments, less than ±40% of the mean value in some embodiments, less than ±30% of the mean value in some embodiments, less than ±20% of the mean value in some embodiments, less than ±10% of the mean value in some embodiments, or less than ±5% of the mean value, in some embodiments.

As noted above and depicted in FIGS. 3A-3B, particles 320 in the suspension 220 may be drawn into the jet stream 330 and retained in fibers produced by the electrospinning process. According to some embodiments, the particles 320 in suspension comprise organic active pharmaceutical ingredients. In some implementations, the particles 320 comprise organic crystalline APIs. The crystalline particles may include aggregates of the particles. In some embodiments, the particles may exhibit substantially a single crystal morphism. In other embodiments, the crystalline particles may be polymorphic.

There may be a range of sizes of particles retained by the electrospun fibers. In some embodiments, the particle sizes may range from about 0.1 μm to about 100 μm. In other embodiments, particles of a selected size distribution may be present in the electrospun fibers. The selected size distribution may be determined ahead of time, e.g., by preparing a suspension with particles of a selected size distribution as described below. Particles retained by the fibers may be smaller than the diameters of the fibers and/or larger than the diameters of the fibers.

In some embodiments, there may be additional particles dispersed within the fibrous composition that are not retained by the fibers, e.g., free from the fibers but substantially entangled within the fibrous mesh. The dispersed particle sizes may range from about 0.1 μm to about 100 μm. In some embodiments, the dispersed particles may be larger than 100 μm. In other embodiments, dispersed particles of a selected size distribution may be present in the fibrous mesh. The selected size distribution may be determined ahead of time, e.g., by providing particles of a selected size distribution for dispersion within the mesh. Particles dispersed within the fibrous mesh may be smaller than the diameters of the fibers and/or larger than the diameters of the fibers. According to some embodiments, an average particle size of particles dispersed within the mesh may be larger than an average pore size of the mesh.

In some embodiments, large particles from the suspension may break free of fibers during the electrospinning process and end up dispersed within the fibrous mesh. In some implementations, particles may be dispersed within the mesh by auxiliary deposition of free particles during the electrospinning process. The auxiliary deposition may be carried out by spraying the particles onto the deposition substrate as the fibrous mesh forms, or after formation of the fibrous mesh. For example, the particles may be sprayed from a suspension which contains a highly volatile carrier liquid and no polymeric binder. In some implementations, the carrier liquid may contain a binder and/or surfactant that coats the sprayed particles. The added binder and/or surfactant may be selected to promote adhesion to the polymer fibers. According to one embodiment, auxiliary deposition may comprise “electrospinning” or electrospraying a second suspension containing no binder at substantially the same time as the regular electrospinning process. Auxiliary deposition may be used to increase the particle or API loading of the fibrous mesh.

In various embodiments, morphology of the crystalline particles is preserved throughout the electrodeposition process. That is to say, the morphology of the crystalline particles can be maintained from the time the particles are in suspension, through the electrodeposition process, and after the particles have been deposited within fibers on the substrate. The ability to maintain the morphology of crystalline particles throughout the electrodeposition process can allow one to control the properties of the particles in the finally formed fibrous material, for example, by controlling the properties of the particles within the suspension from which the fibrous material is formed. One attribute that aids in preservation of the crystal morphology is execution of the electrospinning process at room-temperature. A method to further preserve crystalline morphology, as well as particle size characteristics, is to select a carrier liquid for the suspension in which the crystalline API is insoluble or weakly soluble. As used herein, a material is “insoluble” in a carrier liquid when 1 wt % or less of the material is dissolved within the carrier liquid at equilibrium, after adding the material to the carrier liquid in a weight ratio of at least about 1:100, material:carrier liquid. A material is “weakly soluble” in a carrier liquid when between about 1 wt % and about 25 wt % of the material is dissolved within the liquid medium at equilibrium, after adding the material to the carrier liquid in a weight ratio of at least about 1:100, material: carrier liquid. Since the API is insoluble or weakly soluble in the carrier liquid, the crystal morphology and particle size will be substantially persevered in the electrospinning process.

According to some embodiments, morphology of some crystalline APIs may change during the electrospinning process. For example, in some electrospinning processes, the crystalline particles may undergo a phase transition from one crystal polymorph to another polymorph. Crystalline phase transitions may be dependent upon any combination of heat, choice of carrier liquid, choice of polymer, and applied voltage. In some embodiments, an electrospinning process is selected such that crystalline particles comprising an API transition from a less pharmaceutically effective polymorph in suspension to a more effective morphology in the electrospun fibers.

Accordingly, a method for preparing a suspension 220 may comprise identifying an API to be used, and selecting a carrier liquid in which the API is insoluble or weakly soluble. The method may further include selecting a polymeric binder that is soluble in the carrier liquid. The carrier liquid and polymeric binder may be mixed so as to dissolve the polymeric binder in the carrier liquid to form a solution. The particles of API may then be added to the solution and the solution agitated prior to electrospinning to produce a suspension of the crystalline particles. Agitation may be executed using ultrasonic techniques. In some embodiments, sonication can break up larger aggregates of the particles. A similar process may be used for non-crystalline, organic APIs.

Some crystalline APIs have preferred crystalline morphologies for pharmaceutical effectiveness. As can be appreciated, downstream processing of a carefully prepared crystalline API of a preferred morphology should not alter the morphology, which could potentially render the drug ineffective. The process of electrospinning fibrous compositions from suspensions as described above in various embodiments is well suited for downstream processing of certain APIs, without altering the API morphology.

Any one of or combination of a variety of carrier liquids and polymers may be used in preparing suspensions of APIs. In some embodiments, organic (meaning carbon-containing) carrier liquids may be used to prepare suspensions of APIs for electrospinning. While any carrier liquid generally useful to prepare a polymer solution may be used for preparation of the suspension, the fiber diameter, matrix pore size, and polymer structure may be influenced by the carrier liquid used to form the fibrous compositions. Examples of carrier liquids include, but are not limited to, water, ethanol, methanol, dimethylsulfoxide (DMSO), ethyl acetate, benzene, 2-butanone, carbon tetrachloride, n-heptane, n-hexane, n-pentane, methylene chloride, dimethylformamide, chloroform, formic acid, ethyl formate, acetic acid, hexafluoroisopropanol, cyclic ethers, acetone, C₂-C₅ alcohol acetates, 1-4 dioxane, tetrahydrofuran, dichloromethane, 1-propanol, 2-propanal, anisole, 1-butanol, 2-butanol, butyl acetate, tert-butyl methyl ether, cumene, ethyl ether, formic acid, heptane, isobutyl acetate, isopropyl acetate, methyl acetate, 3-methyl-1-butanol, methylethyl ketone, methyl isobutyl ketone, 2-methyl-1propanol, pentane, 1-pentanol, propyl acetate, and combinations thereof. In some embodiments, the carrier liquid is selected to be noncytotoxic.

Boiling points for carrier liquids used for electroprocessing may be relatively low, e.g., between about 30° C. and about 120° C., though in some embodiments liquids with lower or higher boiling points may be used. Surface tension values for carrier liquids may be between about 20 mN/m and about 50 mN/m, though in some embodiments liquids with lower or higher surface tension values may be used. Conductivity of a carrier liquid may be greater than approximately 0.001 uS/cm, but in some implementations, the addition of the polymer and/or API may raise the conductivity to appropriate levels. In some embodiments, a salt may be added to increase the conductivity.

In some implementations, non-boidegradable polymers may be used in preparing suspensions 220. Examples of non-boidegradable polymers include, but are not limited to, polyurethanes (meaning a thermoplastic polymer produced by the reaction of polyisocyanates with linear polyesters or polyethers containing hydroxyl groups), polyvinylidine fluoride, and polyvinylidine fluoride trifluoroethylene. In some embodiments, biodegradable polymers may be used. Examples of boidegradable polymers include, but are not limited to, poly(lactic acid-glycolic acid), poly(lactic acid), poly(glycolic acid), a poly(orthoester), a poly(phosphazene), poly(caprolactone), a polyacrylamide, polyvinyl pyrrolidone, and collagen. Additional polymers that may be used include, but are not limited to, the polymers listed in Table 1. The polymers used for preparing the suspension may be biocompatible.

TABLE 1
Polymers for Electrospinning

| | Water solubility | Safe for |
|---|---|---|
| | (for oral dosage | pharmaceutical |
| Polymer | form evaluation) | use? |
| Polyethylene oxide* | Yes | Yes |
| Polyacrylic acid* | Yes | Yes |
| Polyvinyl chloride* | Insoluble | No |
| Polystyrene* | Insoluble | No |
| Poly l-lactide* | Insoluble | Yes |
| Poly methyl methacrylate* | Insoluble | Yes |
| Nylon 6,6* | Believed to be | No |
| | insoluble | |
| Cellulose Acetate | Insoluble | Unsure |
| Poly butyl methacrylate | Soluble in | Yes |
| | gastric juices | |
| Poly 2-dimetyl aminoethyl | Soluble in | Yes |
| | gastric juices | |
| Poly ethyl acrylate | Insoluble | Yes |
| Poly trimethyl amino ethyl | Insoluble | Yes |
| Poly methacrylate chloride | Insoluble | Yes |
| Poly vinyl alcohol | Yes | Yes |
| Methylcellulose\hat{ } | Yes | Yes |
| Ethylcellulose | Insoluble | Yes |
| Hydroxypropyl cellulose\hat{ } | Yes in cold | Yes |
| | water | |
| Hydroxyethyl cellulose\hat{ } | Yes in hot/cold | Yes |
| | water | |
| Hydroxypropylmethyl cellulose\hat{ } | Yes in cold | Yes |
| | water | |
| Hydroxyethylmethyl cellulose\hat{ } | Believed to be | Yes |
| | soluble | |
| Poly (D-lactide) | | Yes |
| Poly (DL-lactide) | No | Yes |
| Polyglycolide | No | Yes |
| Poly (DL-lactide-co-glycolyde) | No | Yes |
| Chitosen | Insoluble | Yes |
| Carrageenan | Gels | Yes |
| Poly(alginic acid) | Insoluble | Yes |
| Xanthan gum | Yes in hot/cold | Yes |
| | water | |
| Gelatin | Yes | Yes |
| Poly(sebacic acid) | | Yes |
| Poly(adipic acid) | | Yes |
| Poly(fumaric anhydride) | | Yes |
| Poly (4,4′-stilbene dicarboxylic | | Yes |
| acid anhydride) | | |

Preparation of a suspension may first comprise preparing a solution of a selected polymer and a carrier liquid. The ratio of polymer to carrier liquid may be selected based upon a desired ensemble average fiber diameter for the fibrous composition. For example, the ratio of polymer to carrier liquid may affect the viscosity of the suspension and thereby influence fiber diameter. The ratio of polymer to carrier liquid may be between about 2% and about 5% by weight in some embodiments, between about 5% and about 10% by weight in some embodiments, between about 10% and about 20% by weight in some embodiments, and yet between about 20% and about 40% by weight in some embodiments.

An amount of API may then be added to the solution to create the suspension. The API may be added to the solution in powder form, e.g., directly from a purified sample of API, or may be first suspended in the carrier liquid, or suspended in a compatible liquid and then added to the solution of polymer and carrier liquid. The ratio of the amount of API to the amount of polymer in the suspension may affect the drug loading of the fibrous composition produced by the electrospinning process. The ratio of API to polymer by weight may be between about 5% and about 10% in some embodiments, between about 10% and about 20% in some embodiments, between about 20% and about 40% in some embodiments, between about 40% and about 60% in some embodiments, between about 60% and about 80% in some embodiments, or between about 80% and about 100% in some embodiments. In some implementations, higher ratios may be used.

The API may include one or more crystal morphologies. In some embodiments, the API may include a fractional amount, by weight, of one or more crystal morphologies. The fractional weight may be between about 1% and about 5% in some embodiments, between about 5% and about 10% in some embodiments, between about 10% and about 20% in some embodiments, between about 20% and about 40% in some embodiments, between about 40% and about 60% in some embodiments, or between about 60% and about 80% in some embodiments. In some implementations, the API may be provided in purified or highly purified forms. The fractional weight may be between about 80% and about 90% in some embodiments, between about 90% and about 95% in some embodiments, between about 95% and about 98% in some embodiments, or between about 98% and about 99% in some embodiments. In additional embodiments, the fractional weight of the one or more crystalline morphologies may be higher than 99%.

In some embodiments, the APIs may be provided in a selected range of sizes. For example, the APIs may be suspended in a carrier liquid and subjected to a filtering or separation process that yields selected size distributions of the particles. In some embodiments, the size distribution of the API particles may be between about 100 nm and about 100 microns (μm), between about 500 nm and about 50 μm in some embodiments, and yet between about 1 μm and about 20 μm in some embodiments. Though, in other embodiments, any selected distribution of sizes may be used.

Additional components may be incorporated in the suspension in some embodiments, and may be either soluble or insoluble in the carrier liquid. For example, excipients that improve the bioefficacy or bioavailability of the API may be added. Polymers that affect solubility of the fibrous composition may be added. In some embodiments, surfactants may be incorporated that improve the entrainment of the particles in the fibers.

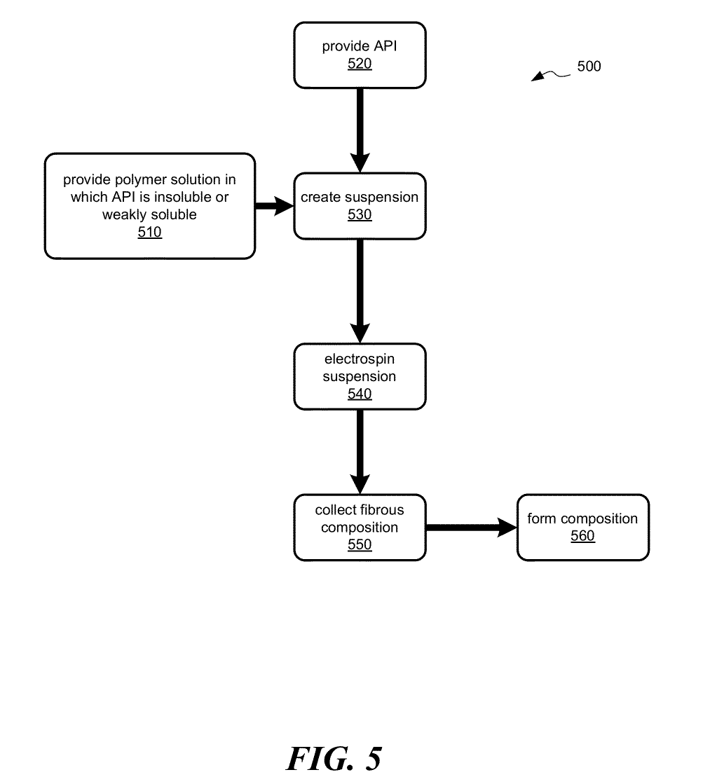

FIG. 5 depicts a method 500 for downstream processing of an API, according to one embodiment. The method may comprise providing 510 a solution of a suitable polymer and carrier liquid, and providing 520 an API in particle or powder form. The particles may be crystalline. The particles of the API and solution may be mixed to create 530 a suspension. The suspension may be subjected to electrospinning 540, and a resulting composition collected 550. The composition may be further processed to form 560 the composition into any useful form, e.g., a tablet, capsule, pad, or patch.

The electrospinning techniques described herein can be applied to producing fibers containing a wide variety of particles for many applications, including fibers containing drug crystals for pharmaceutical dosage forms, fibers containing particles to increase the surface area for catalysis applications, and fibers containing cells and other biological components for tissue engineered implants. As may be appreciated, APIs or other components retained or dispersed within electrospun fibrous compositions may exhibit higher dissolution rates than similar amounts of compacted powder forms of the same APIs or components. Since the particles may be distributed within the porous fibrous matrix, they present an increased available surface area for dissolution as compared to a compacted powder.

A variety of active pharmaceutical ingredients can be used in association with the systems and methods described herein. A pharmaceutically active composition may be any bioactive composition. In some embodiments, the pharmaceutically active composition may be selected from “Approved Drug Products with Therapeutic Equivalence and Evaluations,” published by the United States Food and Drug Administration (F.D.A.) (the “Orange Book”).

As noted above, the active pharmaceutical ingredient can be crystalline, in certain embodiments. Exemplary crystalline active pharmaceutical ingredients that can be used in association with the systems and methods described herein include, but are not limited to, crystalline forms of Acetaminophen, Ibuprofen, albendazole (ABZ), famotidine (FAM), cromolyn sodium salt, mebendazole, carbamazepine, indomethacin, ketoprofen, chloramophenicol, ketoconazole, itraconazole, tetracycline hydrochloride, chlorotetracycline hydrochloride, amphotericin B, acyclovir, salicylic acid, nabumetone, naproxen, sulindac, ketanserin, clarithromycin, ferulic acid, rifampin, paclitaxel, doxorubicin hydrochloride, flufenamic acid, acetazolamide, piracetam, sulfamerazine, mefenamic acid, nitrofurantion, nifedipine, sulfathiazole, cefaclor, norfloxacin, cephradine, levodopa, methazolamide, nystatin, paromomycin sulfate phenelzine sulfate, piperazine citrate, baclofen, ceforanide, fenbendazole, mesalamine, norfloxacin, allantoin, azathioprine, carbidopa, cefadroxil, cephalexin, cephradine, codeine sulfate, dimethicone, epinephrine, furazolidone, gentamicin sulfate, iopamidol, lisinopril, magaldrate, reserpine, riboflavin. Of course, the invention is not limited to the use of crystalline APIs, and in other embodiments, amorphous APIs (e.g., amorphous forms of aliskiren, carbamazepine (CBZ), ibuprofen and its sodium salt, indomethacin, chloramphenicol, acetaminophen, ketoprofen, or amorphous forms of the above-listed crystalline pharmaceuticals, etc.) could be employed.

### EXAMPLES

### I. Theoretical Analysis

To gain an understanding of the mechanics of the formation of the fibrous structures, a theoretical analysis of the process was developed. A summary of the theoretical findings are presented below. In the analysis, only the rotating wire type used for free-surface electrospinning was considered and an assumption was made that the particles are perfect spheres of density equal to that of polystyrene, 1.05 g/cm³.

During the entrainment process, the rotating wire experiences several forces (capillary, inertial, viscous, and gravitational forces) as it travels vertically through the air/liquid interface of the bath. As the wire approaches the interface, the interface deforms and coats the upper hemisphere of the wire. Once the wire has passed through the original position of the interface, liquid begins to drain from the wire, causing a trailing film to form, as depicted in FIG. 3A. At a distance several times larger than the diameter of the wire, the trailing film ruptures, leaving liquid entrained on the wire.

The configuration employed here is similar to studies where spherical particles are drawn through an interface by mechanical forces or buoyancy forces and entrain liquid through the draining and rupture of a trailing filament. (See, Cohen, I.; Li, H.; Hougland, J. L.; Mrksich, M.; Nagel, S. R., Science, 2001 292, 265-267 and Cohen, I.; Nagel, S. R., Physical Review Letters, 2002, 88, 074501-1 and May, M. H.; Sefton, M. V., Annals of the New York Academy of Sciences, 1999, 875, 126-134.) Computational studies have shown that the liquid entrainment on a sphere at low Reynolds number (Re) is highly dependent on the capillary number (Ca), a measure of the viscous force relative to the surface force, of the system. (See, Geller, A. S.; Lee, S. H.; Leal, L. G., J. Fluid Mech., 1986, 169, 27-69 and Manga, M.; Stone, H. A., J. Fluid Mech., 1995, 287, 279-298 and Lee, S. H.; Leal, L. G., J. Colloid Interface Sci., 1982, 87, 81-106.) The previous studies describe the entrainment of a liquid on a spherical surface, whereas entrainment on a cylindrical surface is consider in the present analysis. A detailed analysis of a cylinder traveling through a deformable interface has not been carried out, though in some earlier work on free surface electro spinning it was found that the amount of liquid entrained on the wire could be described by the relation z/r_{w}=aCa^{b}, where z is the thickness of the uniform liquid film entrained on a wire of radius r_{w}, and a=0.78±0.03, b=0.21±0.01 for solutions of PVP in ethanol. (See, Forward, K. M.; Rutledge, G. C., Chem. Eng. J., 2011, 183, 492-503.)

In the present study, it was necessary to determine whether the particles (assumed to be polystyrene (PS) beads for the purposes of the analysis) are entrained with the fluid and jet or remain in the solution bath. Due to the low Re of the fluid throughout the process, it is possible to assume that the beads behave as a dilute suspension of spheres in a large fluid bath, and the flow can be approximated by Stokes's flow, given that the bead diameter is much less than the wire diameter. In this analysis, the wire diameter is taken to be 200 μm, and the largest bead diameters is taken to be 10 μm, which values are representative of experimental conditions described below. The main forces acting on the bead are the force due to gravity and the drag force on the bead due to the liquid. Electrical forces that may arise due to accumulation of charge on the PS microparticle itself are ignored.

The force due to gravity, taking into account buoyancy, can be determined by:

F_{gravity}=(ρ_{particle}−ρ_{fluid})*4/3πr³g (1)

where ρ_{particle} is the particle density, ρ_{fluid} is the fluid density, r is the radius of the particle and g is the gravitational acceleration. The drag force can be calculated by Stoke's law:

F_{drag}=6πρrvᵣₑₗ (2)

where ρ is the viscosity of the fluid and vᵣₑₗ is the relative velocity between the fluid (v_{fluid}) and particle (vₚₐᵣₜ):

vᵣₑₗ=v_{fluid}−vₚₐᵣₜ (3)

In order to determine whether the particles will be entrained on the wire or jet with the fluid during electrospinning, vₚₐᵣₜ is calculated to determine whether it is positive (travels with the fluid) or negative (left behind). The physical properties of the polymer solutions used for calculations are listed in Table 2:

TABLE 2
Physical properties of the PVP solutions, 8.6 wt % 1.3
MDa PVP with 4.3 wt % 10 μm PS bead in ethanol and 20
wt % 55 kDa PVP with 10 wt % 10 μm PS beads in ethanol.

| | | | Surface |
|---|---|---|---|
| | Density | Viscosity | tension |
| Fluid | (g/cm³) | (Pa · s) | (mN/m) |
| 1.3 MDa PVP in ethanol (8.6 wt %) | 0.82 | 0.137 | 23 |
| 55 kDa PVP in ethanol (20 wt %) | 0.85 | 0.028 | 23 |
| 1.3 MDa PVP (8.6 wt %), 10 μm PS | n/a | 0.154 | n/a |
| beads (4.3 wt %) in ethanol | | | |
| 55 kDa PVP (20 wt %), 10 μm beads | n/a | 0.035 | n/a |
| (10 wt %) in ethanol | | | |

First, the settling of the beads in the fluid bath is considered, where v_{fluid} is equal to zero. In this case, the settling velocity of the PS beads in 1.3 MDa PVP and 55 kDa PVP, determined by equating F_{gravity} and F_{drag} and solving for vₚₐᵣₜ is very small. For the largest bead size used in this study, 10 μm, the settling velocity is calculated to be −3.5×10⁻⁵ cm/s and −1.5×10⁻⁵ cm/s for the 1.3 MDa and 55 kDa solutions, respectively. This is slow, and means that it would take more than 6 hours for a particle to travel to a depth of 0.8 cm from the surface of the suspension. Since electrospinning operation may run for about 30 min to produce a sample, this settling is not a large concern. For larger particles, the settling becomes a greater issue, e.g., 100 μm particles are expected to settle out in less than 4 min.

Next examined is the entrainment process. The velocity of the fluid away from the fluid bath during entrainment can be approximated by the velocity of the wire. This can be calculated by:

v_{fluid}=2rₛπΩ (4)

where rₛ is the radius of the spindle and Ω is the rotation rate. Equating F_{gravity} and F_{drag} (Equations 1 and 2) and using equations 3 and 4 for the relative velocity, the velocity of the particle can be determined as a function of the particle diameter, allowing an evaluation as to whether the particle will remain entrained on the wire.

The predicted velocity of the particle during entrainment was calculated using the parameters from an experiment described below. The diameter of the wire was 200 μm, the radius of the spindle was 3.2 cm, the rotation rate was 8.8 rpm. The calculated particle velocity for the 55 kDa PVP and 1.3 MDa PVP solutions was 2.92 cm/s and did not change appreciably as a function of particle diameter for particle diameters up to 100 μm. This indicates that for particle diameters up to one-half the wire diameter, the velocity is positive and the particles will remain within the fluid during entrainment.

For the inclusion of the beads during jetting, determining the precise velocity of the fluid is non-trivial. Many researchers have developed methods to analyze the flow of an electrospinning jet, but they involve complex numerical simulations, which are outside the scope of this study. In lieu of calculating the precise velocity, some authors estimate the velocity based on the volumetric flow rate (Q):

v_{fluid}=Q*A (5)

where A is the area of the jet, determined from the radius of the jet immediately past the Taylor cone. From experimental observations, this radius is approximately 10 μm, based on image analysis. For needle elctrospinning with a metering pump, Q is a known input parameter, but for free-surface electrospinning Q is unknown. To estimate Q for free-surface electrospinning, the lifetime of a jet and the volume of the drop are used, assuming that the flow rate is approximately the volume of the drop divided by the jet lifetime.

$$Q = \frac{{V}_{drop}}{{t}_{jet}} \qquad ( 6 )$$

The lifetime of the jet was determined to be 1.28 s for a 30 wt % solution of 55 kDa PVP in ethanol electrospun at an applied voltage of 30 kV. To determine the volume of the drop, V_{drop}, the correlation reported previously in the work of Forward was used:

$$\begin{matrix}{V}_{drop} = \frac{2 {π}^{2} {r}_{w}^{3} [ {( 1 + 0.78 {Ca}^{0.21} )}^{3} - 0.78 {Ca}^{21} - 1 ]}{0.0028 {V}_{A} + 0.5} \\ where & ( 7 ) \\ Ca = \frac{{v}_{fluid} * η}{γ} & ( 8 )\end{matrix}$$

and V_{A} is the applied voltage in kV, r_{w} is the radius of the wire, v_{fluid} is the velocity of the fluid during entrainment, and γ is the surface tension. The polymer solutions employed in Forward's work are similar to the 20 wt % 55 kDa and 8.6 wt % 1.3 MDa PVP solutions used in the experiment described below and for the purposes of this analysis. Forward's polymer solutions were also spun at approximately 30 kV, so the values and correlations reported there are taken as a reasonable first approximation in this analysis as well.

Equating F_{gravity} and F_{drag}, equations 1-3 and 5-8 may be solved to yield the velocity as a function of particle diameter. Knowing particle velocity as a function of particle diameter allows a determination to be made as to whether the particles remain in the fluid during jetting. The theoretical results indicate a velocity of approximately 10.6 cm/s for particle diameters up to about 100 μm for both polymer solutions. These results indicate that PS particles up to about 100 μm in diameter suspended in PVP/ethanol solutions should be suitable for producing fibrous compositions with the particles distributed therein via free-surface electrospinning.

### II. Experiment 1

### Free-Surface Spinning of a Suspension of Microscale Polystyrene Spheres

In a first experiment, free-surface spinning and needle spinning of suspensions of microscale polystyrene spheres were carried out. High-throughput free-surface electrospinning techniques were used to prepare fibers retaining microparticles. The spinnability of polyvinylpyrrolidone (PVP) solutions containing suspended polystyrene (PS) beads of about 1, 3, 5, and 10 μm diameter was tested in order to better understand free surface electrospinning of particle suspensions. PS bead suspensions with both 55 kDa PVP and 1.3 MDa PVP were found to be spinnable at 1:10, 1:5 and 1:2 PS:PVP mass loadings for all particle sizes studied. The final average fiber diameters of the electrospun fibers ranged from about 0.47 to about 1.2 μm and were found to be substantially independent of the particle size and particle loading. The results indicate that the fiber diameter can be smaller than the particles entrained and can furthermore be adjusted based on solution properties and electrospinning parameters, as is the case for electrospinning of solutions without particles.

Materials:

Materials used in this experiment included the following items. PVP (1.3 MDa and 55 kDa) and lead (Pb) particles with diameters of less than 44 μm (325 mesh) were purchased from Sigma Aldrich (St. Louis, Mo.) and ACS grade ethanol was purchased from VWR International (West Chester, Pa.). Dry 1 μm and 3 μm PS beads were purchased from Polysciences, Inc (Warrington, Pa.), and dry 5 μm and 10 μm PS beads were purchased from Microbeads AS (Skedsmokorset, Norway).

Electrospinning:

Solutions of 8.6 wt % 1.3 MDa PVP containing 0.9 wt %, 1.7 wt % and 4.3 wt % PS beads in ethanol were prepared in order to fabricate fibers with nominal PS:PVP loadings by mass of 1:10, 1:5 and 1:2, respectively. Solutions of 20 wt % 55 kDa PVP containing 2 wt %, 4 wt % and 10 wt % PS beads in ethanol were prepared in order to fabricate fibers with nominal PS:PVP loadings by mass of 1:10, 1:5 and 1:2, respectively, for that molecular weight. These solutions were prepared for all four PS bead diameters: 1 μm, 3 μm, 5 μm, 10 μm, for a total of 24 solutions for electrospinning.

Prior to spinning, the solutions were mixed with a vortex mixer and sonicated for 1 min in an ultrasonic bath. The solutions were spun using both the single needle and free surface approaches immediately after sonication.

For single-needle electrospinning, charged fluid was pumped from a syringe through a needle. With sufficient electric field, the drop at the tip of the needle forms a Taylor cone and then jets, resulting in electrospinning. The needle spinning apparatus was arranged in a parallel plate configuration and equipped with a Harvard Apparatus PHD Infusion 2000 syringe pump and a Gamma High Voltage HV power supply model number ES30PN. Experiments were performed with a needle-to-ground distance of 23 cm, and the flow rate and voltage were chosen such that a stable jet was formed, generally ranging from 0.01-0.03 mL/min for the flow rate and 20-30 kV for the voltage.

For free surface electrospinning, a wire spindle geometry was used. In this configuration, a wire spindle rotated through a charged solution, e.g., as depicted in FIG. 2A. Both the wire electrode and the suspension bath were connected to the high voltage, and the deposition plate was connected to a ground potential. The rotation rate of the wire spindle was set at 8.8 rpm, the electrode-to-ground distance was set at 20 cm, and the high voltage power supplied to the bath was set to obtain jetting (approximately 30 kV).

Characterization:

The morphology of the electrospun fibers was characterized by scanning electron microscopy (SEM). The samples were sputter coated using a Quorum Technologies SC7640 high resolution gold/palladium sputter coater and examined using a JEOL 6060 SEM at a 5 kV operating voltage. Fiber diameters were measured from the SEM images using ImageJ image analysis software. At least 80 measurements were analyzed per sample, and the measurements were made from multiple images. The diameter was measured only for the fiber in between the beads; measurements for the fiber where the bead is located were not included in the analysis.

The ratio of PS:PVP in the solid fibers was determined by washing approximately 30 mg of the sample with ethanol, dissolving the PVP and washing it through a filter (1 μm pore size for the 3, 5, 10 μm PS beads and 0.45 μm pore size for the 1 μm bead size). The final mass of the filter was determined after drying under vacuum, and the mass of the PS beads was calculated by subtracting the initial mass from the final mass.

The viscosity of a suspensions was measured using an AGR2 Rheometer (TA instruments) and the zero shear viscosity is reported. All solutions showed Newtonian behavior for shear rates less than 100 s⁻¹.

The conductivity of each solution was measured using a VWR Digital Conductivity meter. The surface tension and density of the 8.6 wt % 1.3 MDa PVP in ethanol and 20 wt % 55 kDa PVP in ethanol were assumed to be equal to that measured for 8 wt % 1.3 MDa PVP in ethanol and 20 wt % 55 kDa PVP in ethanol reported by Forward and Rutledge. (See, Forward, K. M.; Rutledge, G. C., Chem. Eng. J., 2011, 183, 492-503.)

Fibrous compositions were produced using the electrospinning processes, and the resulting compositions were analyzed. Various aspects analyzed included loading of the particles in the fibers, and fiber morphology.

Final Loading in Fibers:

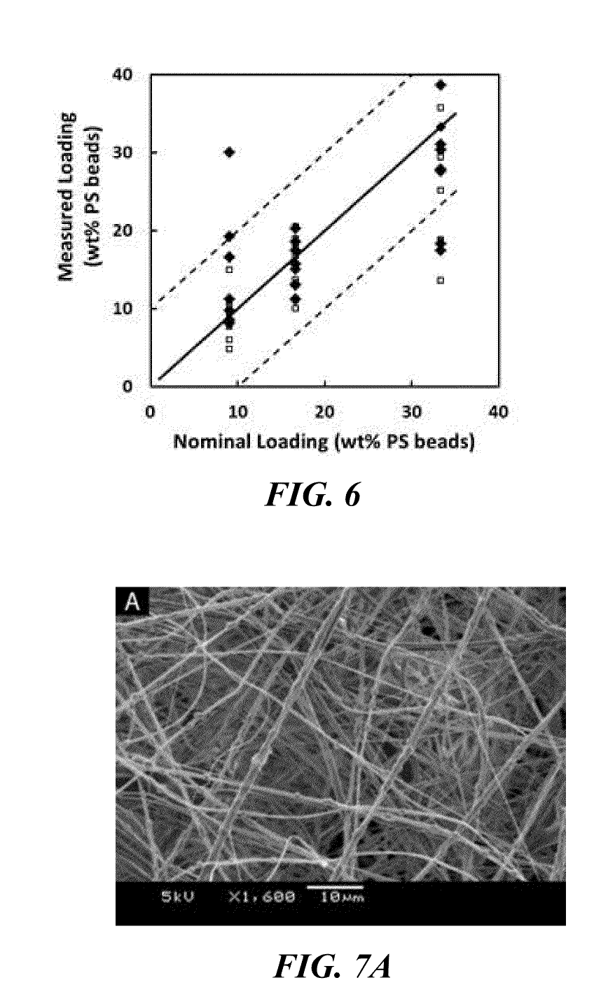

One way of assessing whether the particles were actually entrained in the fluid on the wire and remained with the fluid during jetting is to examine the final loading of PS in the fiber mat. To do this, the weight percent of the PS in the fiber mats was measured for both the free surface and single needle electrospinning processes. The measured mass loading is plotted in FIG. 6 against the nominal mass loading for all solutions electrospun in this study. Assuming complete and uniform entrainment, the parity line is shown by the solid line, and the dotted lines represent +/−10 wt %. It was estimated that the method used for determining loading results included an error margin of approximately +/−10 wt %, due to the low mass being analyzed and the uncertainty of the balance, so the +10 wt % and −10 wt % boundaries (dotted lines) were plotted in the graph of FIG. 6.

The limited accuracy of the measurement is confirmed by the single needle electrospinning results, where entrainment is not an issue and all points should fall on the parity line, according to conservation of mass. The comparison to single-needle electrospinning provides an indication as to how well particles may be spun in free surface electrospinning. Most points for both cases fall within the 10 wt % error boundaries. There are two points that fall outside of the boundaries for the single needle electrospinning and three points that fall outside for free surface, an insignificant difference. Thus, it can be concluded that there are no large deviations of the loading from the expected loading, and the suspensions are electrospinnable. This is also consistent with observations from SEM.

Fiber Morphology:

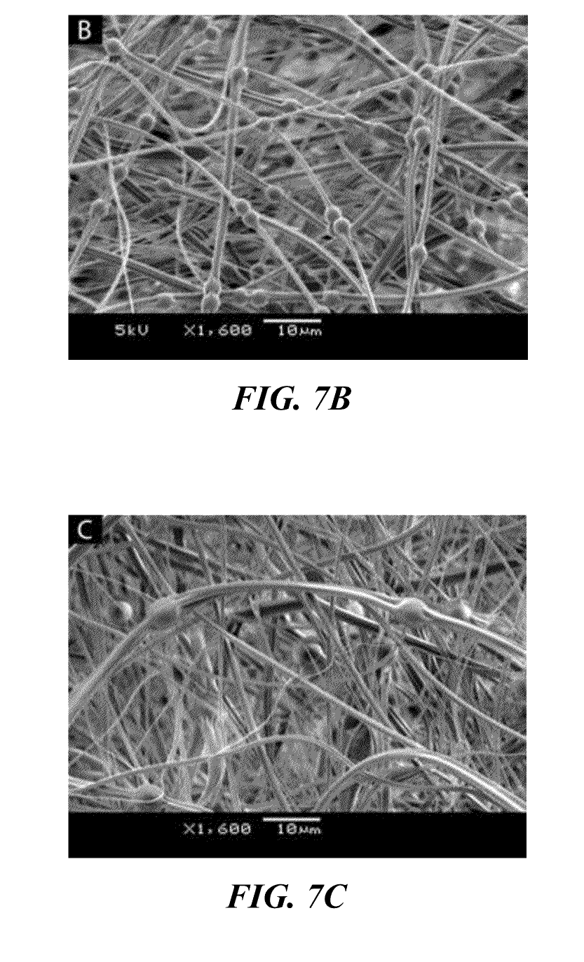

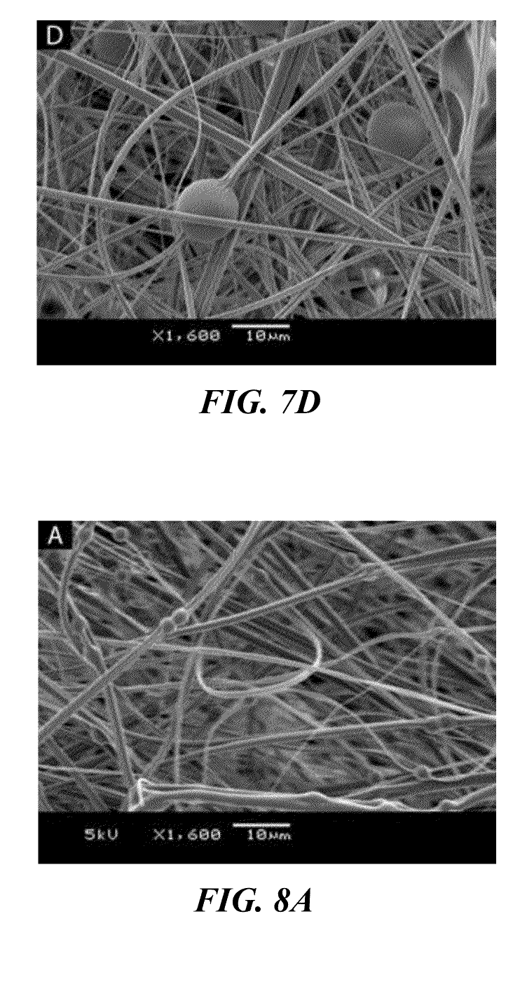

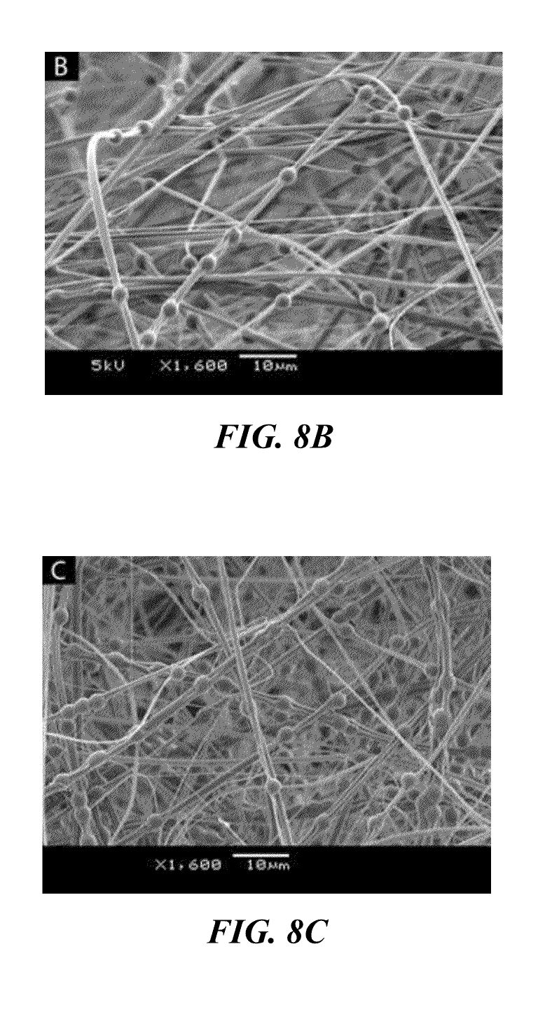

All samples were examined by scanning-electron microscope (SEM) analysis to evaluate their morphology. The SEM images in FIGS. 7A-7D and FIGS. 8A-8C show fibrous compositions retaining polystyrene beads, as produced using free-surface electrospinning. FIGS. 7A-7D show images of the 1.3 MDa PVP, 1:5 PS:PVP mass loading mats for all four different PS bead sizes. It can be seen from these images that the fibers have a mostly smooth morphology and their diameters are smaller than the size of the beads. For the composition of FIG. 7A 1 μm beads were used, at a nominal loading of 1:5 in 1.3 MDa PVP. The average fiber diameter was measured to be 1.07+/−0.17 μm. Corresponding parameters for FIGS. 7B-7D are as follows: (FIG. 7B) 3 μm beads, 1:5 loading, 1.3 MDa PVP, average fiber diameter 1.17+/−0.23 μm; (FIG. 7C) 5 μm beads, 1:5 loading, 1.3 MDa PVP, average fiber diameter 0.97+/−0.32 μm; and (FIG. 7D) 10 μm beads, 1:5 loading, 1.3 MDa PVP, average fiber diameter 1.05+−0.32 μm.

FIGS. 8A-8C show results for the 1.3 MDa PVP, 3 μm beads where three different nominal mass loadings were used in separate trials: 1:10, 1:5, and 1:2 PS:PVP. As can be seen from these images, the fiber morphologies appear smooth and uniform between beads with fiber diameters being smaller than the bead size. Further the morphology is very similar from one sample to the next, substantially independent of the mass loading of PS beads. Accordingly, for the 3 μm beads the loading has no appreciable effect on fiber morphology up to about a loading ration of 1:2 PS:PVP. Experimental parameters for the compositions shown in FIGS. 8A-8C are as follows: (FIG. 8A) 1:10 loading, 3 μm beads, 1.3 MDa PVP, average fiber diameter 1.33+/−0.25 μm; (FIG. 8B) 1:5 loading, 3 μm beads, 1.3 MDa PVP, average fiber diameter 1.23+/−0.18 μm; and (FIG. 8C) 1:2 loading, 3 μm beads, 1.3 MDa PVP, average fiber diameter 0.97+/−0.22 μm.

Fiber Diameter:

An average fiber diameter calculated from at least 80 measurements was determined for each of the samples, and is reported in Table 3. From the results in Table 3, it can be seen that the fiber diameter is substantially independent of the PS bead diameter within each similar group (same PVP base solution and same bead loading). For all cases the average fiber diameter falls within one standard deviation of the other distributions of the group.

To examine the effect of bead loading, fiber diameters for fibers spun from suspensions were compared to the fiber diameters for PVP fibers containing no PS beads. The average fiber diameter for 1.3 MDa PVP fibers containing no beads spun under the same conditions is close to that for all bead-containing fibers electrospun from the 1.3 MDa PVP base solution. In addition, all values for the 55 kDa PVP containing beads fall near the average for 55 kDa fibers containing no beads. These results indicate that the fiber diameter is substantially independent of the bead size as well as bead loading for the materials studied. The fiber diameter can thus be adjusted independently of the diameter of the bead and bead loading, up to at least about a 10 μm bead diameter and a 1:2 bead-to-polymer loading. For example, fiber diameter may be altered by adjusting the base solution properties, for example by changing the concentration or molecular weight of the polymer.

Particle Aggregation:

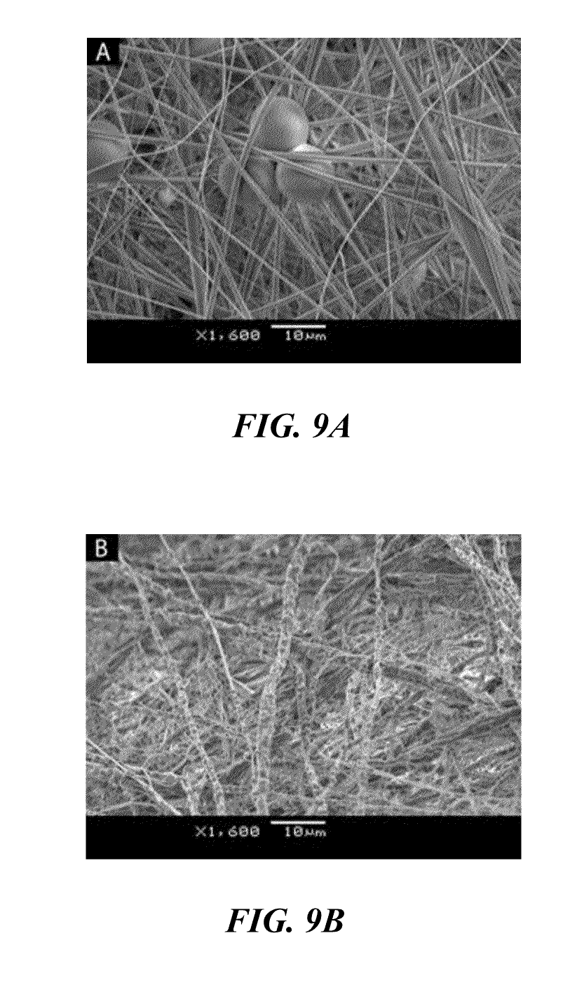

It was observed that in some cases, aggregation of the particles occurred in the experimental trials. For example, aggregation was noted in FIGS. 7A-7B and FIGS. 8A-8C. For some of the single needle formulations, the spinning was so slow that aggregation of particles occurred in the bath prior to entrainment, resulting in aggregates present in the fibers rather than single, separated beads. This is illustrated in FIG. 9A for 10 μm PS beads in a 1:2 PS:PVP mass loading prepared by single needle electrospinning. For the single needle electrospinning results shown in FIG. 9A, the spinning parameters were 1:2 loading, 1.3 MDa PVP, and 10 μm beads.

TABLE 3
Average diameter of fiber between PS
beads for each solution electrospun.

| | | | Diameter (μm) |
|---|---|---|---|
| | | | average +/− |
| Bead | PS:PVP | PVP Molecular | standard deviation |
| Diameter | loading | Weight | of distribution |

| | | | | | |
|---|---|---|---|---|---|
| 1 | μm | 1:10 | 1.3 | MDa | 1.11 +/− 0.22 |
| 3 | μm | 1:10 | 1.3 | MDa | 1.33 +/− 0.25 |
| 5 | μm | 1:10 | 1.3 | MDa | 1.17 +/− 0.30 |
| 10 | μm | 1:10 | 1.3 | MDa | 0.94 +/− 0.21 |
| 1 | μm | 1:5 | 1.3 | MDa | 1.13 +/− 0.23 |
| 3 | μm | 1:5 | 1.3 | MDa | 1.19 +/− 0.22 |
| 5 | μm | 1:5 | 1.3 | MDa | 0.88 +/− 0.22 |
| 10 | μm | 1:5 | 1.3 | MDa | 0.98 +/− 0.30 |
| 1 | μm | 1:2 | 1.3 | MDa | n/a* |
| 3 | μm | 1:2 | 1.3 | MDa | 0.96 +/− 0.18 |
| 5 | μm | 1:2 | 1.3 | MDa | 0.88 +/− 0.15 |
| 10 | μm | 1:2 | 1.3 | MDa | 1.11 +/− 0.34 |
| 1 | μm | 1:10 | 55 | KDa | 0.66 +/− 0.08 |
| 3 | μm | 1:10 | 55 | KDa | 0.48 +/− 0.16 |
| 5 | μm | 1:10 | 55 | KDa | 0.56 +/− 0.10 |
| 10 | μm | 1:5 | 55 | KDa | 0.47 +/− 0.11 |
| 1 | μm | 1:5 | 55 | KDa | 0.66 +/− 0.15 |
| 3 | μm | 1:5 | 55 | KDa | 0.84 +/− 0.27 |
| 5 | μm | 1:5 | 55 | KDa | 0.50 +/− 0.12 |
| 10 | μm | 1:5 | 55 | KDa | 0.60 +/− 0.22 |
| 1 | μm | 1:2 | 55 | KDa | 0.56 +/− 0.10 |
| 3 | μm | 1:2 | 55 | KDa | 0.56 +/− 0.12 |
| 5 | μm | 1:2 | 55 | KDa | 0.53 +/− 0.11 |
| 10 | μm | 1:2 | 55 | KDa | 0.54 +/− 0.14 |

| | | | | |
|---|---|---|---|---|
| None | None | 1.3 | MDa | 1.19 +/− 0.44 |
| None | None | 55 | KDa | 0.72 +/− 0.23 |

*Could not be measured due to aggregation

Aggregation was also observed for compositions produced by free-surface electrospinning, as can be seen in FIG. 9B (and also in FIGS. 7A-7B and FIGS. 8A-8C). For the free-surface electrospinning results shown in FIG. 9B, the spinning parameters were 1:2 loading, 1.3 MDa PVP and 1 μm beads.

In some implementations, agitation of the suspension, e.g., sonication during the electrospinning, could be used to mitigate particle aggregation. In some embodiments, surfactants may be added to the suspension to mitigate particle aggregation. High nominal particle loadings could also produce challenges for electrospinning, both with respect to aggregation, as well as with respect to fluid entrainment. The entrainment predictions for this study using the theoretical analysis described above assumes dilute solutions.

Spinning of Pb Particles:

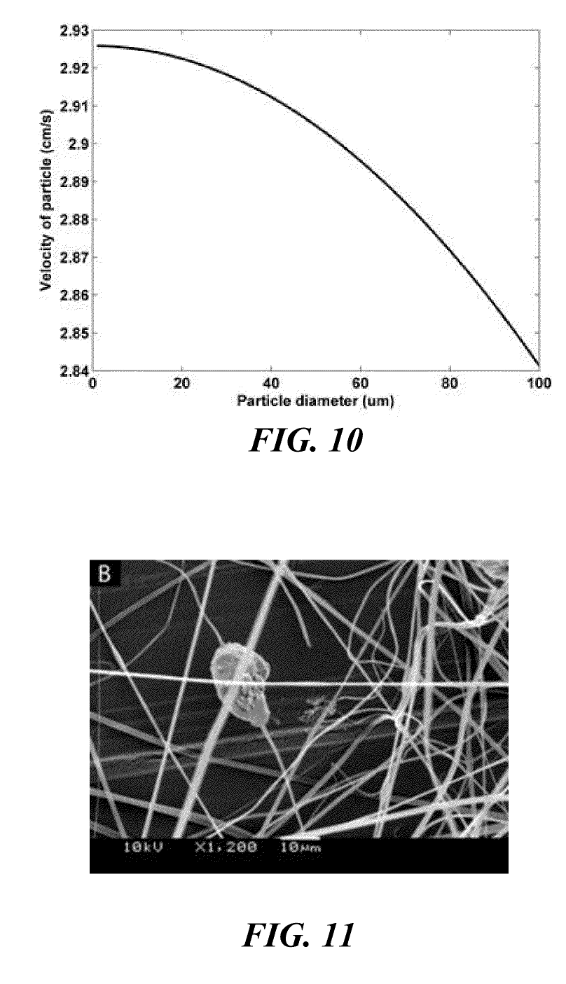

All formulations chosen for the experimental trials were “electrospinnable”. This is consistent with the theoretical predictions based on particle settling, fluid entrainment and jetting. To investigate an upper bound for particle spinning, a scenario where the polymer fluid was the 8.6 wt % 1.3 MDa PVP, e.g. as used in the trials, and a particle density as high as lead (approximately 12 g/cm³) was considered. Under such conditions, the lead beads would still be expected to be entrained in the fluid up to a diameter of about 100 μm. This can be seen from the graph of FIG. 10, which shows a predicted velocity of lead particles during fluid entrainment as a function of particle diameter for a solution of 8.6 wt % 1.3 MDa PVP.

For Pb particles, the settling velocity can become a significant factor. For the case of 8.6 wt % 1.3 MDa PVP and a lead particle, the settling velocity for a 5 μm diameter particle is about −2×10⁻⁴ cm/s, for a 30 μm diameter particle is about −0.007 cm/s, and for a 100 μm diameter particle is about −0.08 cm/s. These velocities correspond to complete settling times of 4000 s, 110 s, and 10 s, respectively for the experimental conditions used.

To test whether lead particles would be entrained in the fluid and jet, lead particles of diameter less than 44 μm were scattered onto the top of the fluid bath. Immediately thereafter, spindle rotation was initiated and the electric field applied. The spinning progressed for approximately 30 s, and then a sampled of the produced composition was collected and prepared for analysis using a SEM. An image of the composition is shown in FIG. 11. FIG. 11 shows that lead particles of at least about 10 μm×20 μm are spinnable with 8.6 wt % 1.3 MDa PVP if the particles can be made to remain suspended in the fluid bath.

Discussion:

Electrospinning may be a viable process to create fibers with more complex geometries that retain particles with diameters up to at least about 10 μm. By varying conditions of the suspension, e.g., increasing the viscosity and/or conductivity of the fluid, larger particles may be used. In this experiment, various bead diameters and polymer molecular weights were shown to be spinnable up to a 1:2 PS:PVP mass loading. The produced fiber diameters were independent of the bead size and bead loading, and were mainly dependent on the solution properties, such as viscosity and conductivity, and similar to fibers spun without any beads at all. These results indicate that a wide variety of particles can be electrospun for many applications, and that the final bead and fiber dimensions can be controlled. Further, results obtained using free-surface electrospinning of suspensions suggest the technique may be used for industrial mass production processes.

### III. Experiment 2

### Free-Surface Spinning of a Suspension of Particles of Crystalline APIs

This experiment was carried out to investigate the use of electrospinning for forming solid dispersions containing crystalline active pharmaceutical ingredients (API), and to analyze properties of the resulting materials. Free-surface electrospinning was used to prepare fibrous compositions of polyvinylpyrrolidone (PVP) and crystalline albendazole (ABZ) or famotidine (FAM) from suspensions of the drug crystals in a polymer solution. Scanning-electron microscopy, x-ray diffraction (XRD), and differential scanning calorimetry (DSC) were used to characterize the electrospun compositions. XRD was used to determine the polymorphism of the crystalline particles before and after the electrospinning process. Measurements were made to determine particle loading in the compositions, and dissolution studies were performed to determine the influence of the preparation method on the dissolution rate.

In brief, the results showed that fibrous compositions containing 31 wt % ABZ and 26 wt % FAM for the 1:2 ABZ:PVP and 1:2 FAM:PVP formulations, respectively, could be produced using the electrospinning process. Additionally, both the ABZ and FAM APIs retained their polymorphism throughout processing. The crystals had an average size of about 10 μm and were well-distributed throughout the fibers. Significantly higher dissolution rates were observed for compressed electrospun tablets than compressed powder tablets of the same API.

Materials and Electrospinning:

The materials used for this experiment included PVP (1.3 MDa MW), FAM and ABZ, which were purchased from Sigma-Aldrich (St. Louis, Mo.). American Chemical Society grade ethanol was purchased from VWR International (West Chester, Pa.) and used for preparing suspensions.

To prepare the 1:2 API:polymer electrospinning solutions, 8.6 wt % PVP was dissolved in ethanol and 4.3 wt % API was added to the solution and suspended by stirring. Immediately prior to electrospinning, the solution was sonicated using a Sonics Vibra-cell serial number 48265T ultrasonic processor with a tapered microtip (Sonics and Materials, Newtown, Conn.) in order to ensure that the particles were well-suspended at the start of the electrospinning process. Sonication was performed three times for 40 s each time, with at least 30 s delay between each at 40% maximum amplitude.

A depiction of a free-surface electrospinning apparatus resembling the system used in this experiment is shown in FIG. 2A. A wire spindle rotated through the charged solution bath containing the API/polymer/carrier fluid mixture. As the spindle crosses the air/fluid interface, a thin layer of fluid is entrained on the wire, which breaks into droplets as described above. Under a sufficiently high applied electric field, the droplets form fluid jets and fibers extending towards the grounded collection plate (upwards in this configuration). Electro spinning of each droplet continues until the droplet is depleted or the electric field condition is no longer met.

Sample Analysis:

Scanning electron microscopy (SEM) was used to analyze the morphology of the fibers. A Quorum Technologies SC7640 high resolution gold/palladium sputter coater was used to coat the samples, and a JEOL 6060 SEM at 5 kV operating voltage was used to obtain images. Both X-ray diffraction (XRD) and differential scanning calorimetry (DSC) were used to confirm the presence of crystals and analyze the polymorph present in the electrospun fibers. XRD was performed on a PANalytical X′Pert Pro with a reflection-transmission spinner PW 3064/60 sample stage and a Cu X-ray source with a 1.54 Å wavelength. DSC was performed on a TA DSC Q2000 instrument using a 2-6 mg sample in an aluminum sample pan. The materials were heated at 10° C./min to 250° C. and 200° C. for ABZ and FAM, respectively.

Particle size analysis was performed on the spinning solutions prior to sonication, after sonication, and 1 hour after sonication. A Malvern Mastersizer 2000 with a Hydro 2000 μP accessory was used to measure the particle size distribution and the volume-based results were used for the analysis. Three measurements were made per sample and the average is reported in this work.

In order to determine the actual drug loading in the electrospun fibers, samples were analyzed with a Perkin-Elmer (Waltham, Mass.) double-beam Lambda25 UV-vis spectrophotometer. A standard curve was prepared for ABZ in methanol for concentrations from 0.005 mg/mL to 0.05 mg/mL at an absorbance of 295 nm and for FAM in methanol for concentrations from 0.002 mg/mL to 0.035 mg/mL at an absorbance of 286 nm. PVP does not absorb in the UV range and pure methanol was used for the background spectrum. A known mass of electrospun mat was dissolved in a known volume of methanol and diluted such that the expected concentration of API fell within the concentration ranges covered by the standard curves. From the resulting measured concentration, the mass of API in the original mat sample, and thus the weight percent API in the electrospun mat was calculated. Three measurements were made per API and were averaged to give the reported value.

Dissolution Measurements:

Tablets were made from electrospun material by weighing out 150 mg material and pressing into a 9 mm tablet using a Gamlen Tablet Press model GTP1 in the manual mode. Powder tablets were prepared by weighing out 50 mg API powder and 100 mg PVP powder, mixing for 1 min, and pressing into 9 mm tablets using the same press with the same insertion depth. The electrospun tablets were compared to the compressed powder tablets for analysis. Market formulations of ABZ were not used for comparison because the focus of this study was to examine the effects of using the electrospinning preparation method compared to a powder-based preparation method. It will be appreciated that electroprocessed materials may be further optimized for better dissolution through the use of additional excipients, e.g., by adding excipients used in market formulations to the suspensions or to the crystalline particles prior to mixing into the suspensions.

Dissolution was performed using a Varian VK 7025 dissolution bath (Agilent, Santa Clara, Calif.) and a Cary 50 Bio UV spectrophotometer (Agilent, Santa Clara, Calif.). For ABZ the standard USP methods were used with 900 mL 0.1 N HCl media, apparatus II, 50 rpm paddle speed and a temperature of 37° C. For FAM standard USP methods were used with 900 mL 0.1 M Phosphate buffer media, apparatus II, 50 rpm paddle speed, and a temperature of 37° C. Measurements were made every minute for 90 minutes by probes inserted in the bath and connected to the spectrophotometer by fiber optic cables.

Results—Particle Size:

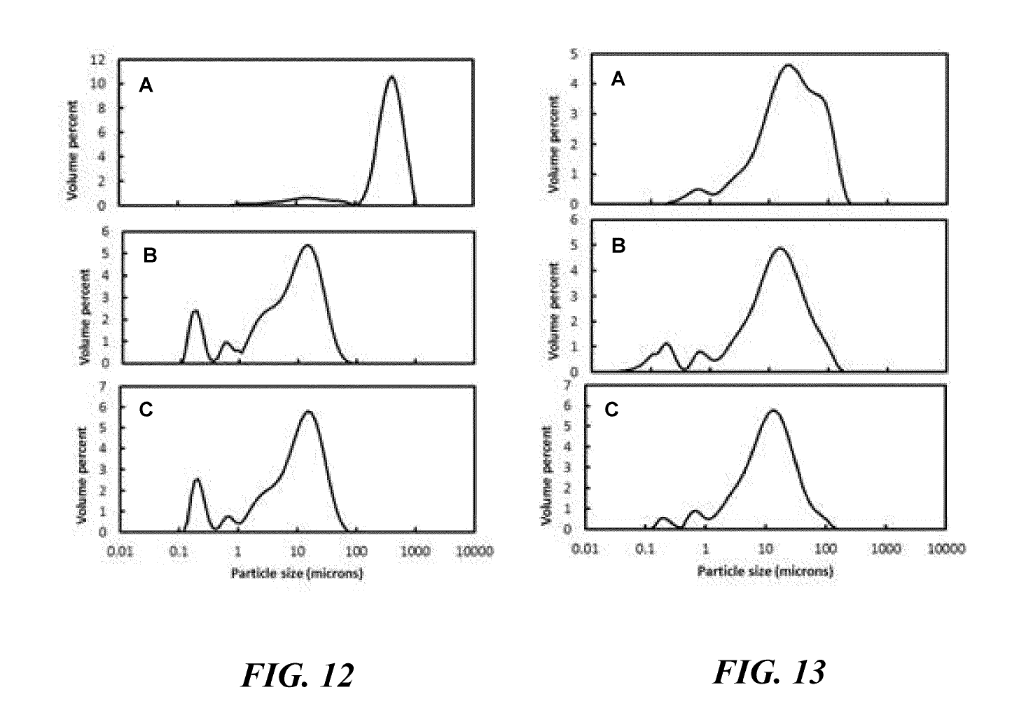

The particle size distributions of the API crystals suspended in the PVP/ethanol solution were measured prior to sonication, after sonication, and after standing for 1 hour. The time span of 1 hour was approximately the length of time to electrospin mats of the fibrous compositions for analysis. The distributions for the ABZ and FAM suspensions are shown in FIGS. 12A-C and 13A-C. FIG. 12 shows 4.3 wt % ABZ crystals suspended in 8.6 wt % PVP in ethanol. FIG. 12A shows the particle distribution before sonication, FIG. 12B just after sonication, and FIG. 12C after sitting for about 1 hour. FIG. 13 shows 4.3 wt % FAM crystals suspended in 8.6 wt % PVP in ethanol. The times at which particle distributions were measured in FIGS. 13A-13C were the same as for the times of FIGS. 12A-12C.

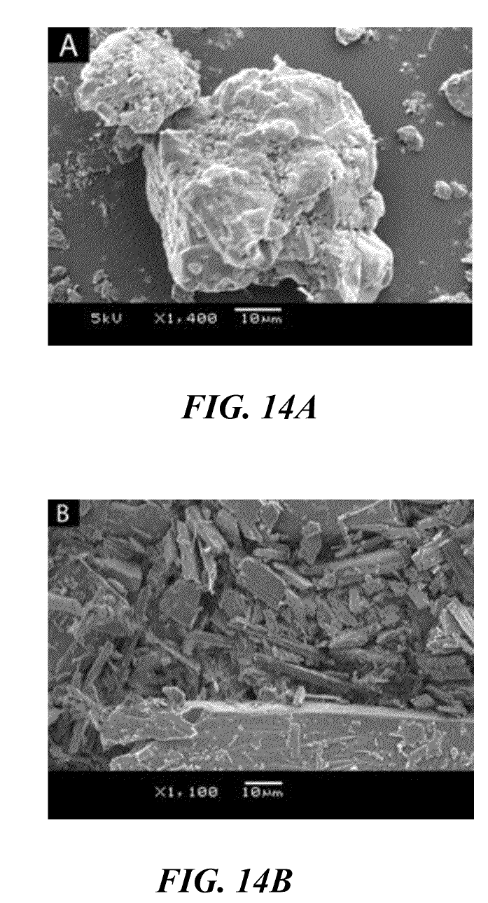

For ABZ, the sonication greatly decreases the crystal size. This is likely due to dispersal of aggregates rather than crystal breakage, as SEM images of the ABZ crystals as received show agglomerates of smaller crystals (FIG. 14A). The FAM particle size distribution does not show a strong change following sonication. This is likely because the FAM crystals as received are not present as agglomerates in the powder, as can be seen in FIG. 14B. Following approximately 1 hour of standing, both suspensions retain their particle size distribution, indicating that the suspensions to be electrospun may substantially retain their particle size distribution throughout the entire electrospinning process.

Results—Composition Morphology:

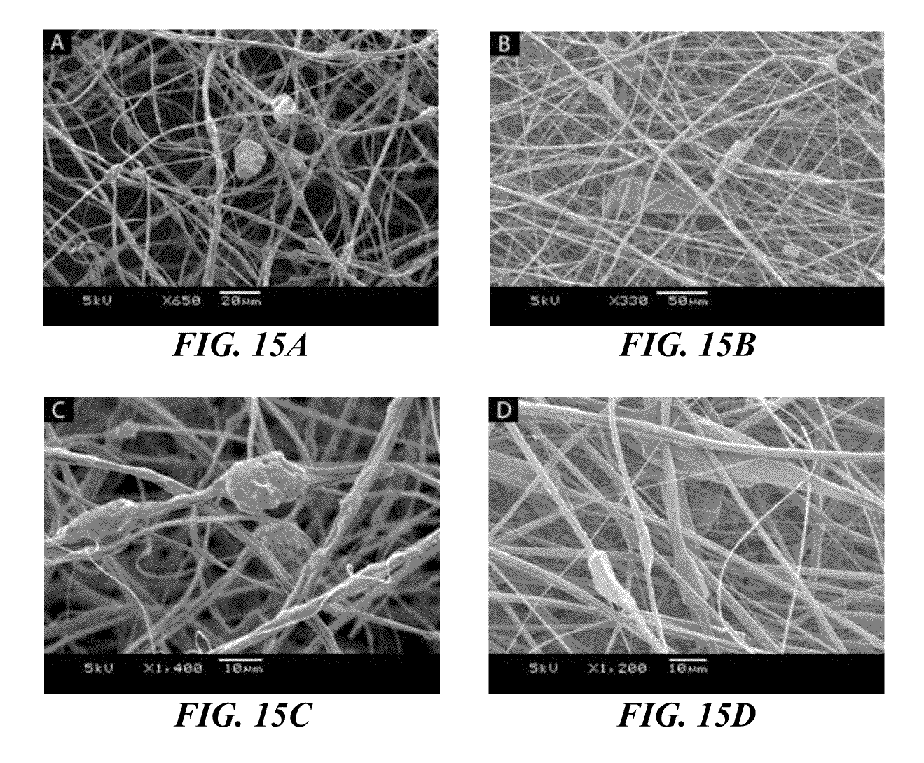

The morphology of the electrospun fibers were examined by SEM, and the images are shown in FIGS. 15A-15D. FIGS. 15A and 15C (higher magnification) show 1:2 ABZ:PVP electrospun fibers. FIGS. 15B and 15D (higher magnification) show 1:2 FAM:PVP electrospun fibers. In both cases, the API crystals are present and mainly retained by the electrospun fibers rather than freely dispersed and entangled within the fiber mesh. For the ABZ particles retained by fibers in the PVP mat, the crystals are present as small agglomerates as well as single crystalline particles, which can be seen by careful examination of the roughness of the fibers, particularly in FIG. 15C. FAM retained by fibers of the PVP composition, on the other hand, shows little agglomeration. The FAM crystals are invariably distributed with their longest side parallel to the fiber. This can be attributed to high shear forces acting on the particles during jetting. (See, Dror, Y.; Salalha, W.; Khalfin, R. L.; Cohen, Y.; Yarin, A. L.; Zussman, E. Langmuir, 2003, 19, 7012-7020.)

Results—Crystallinity:

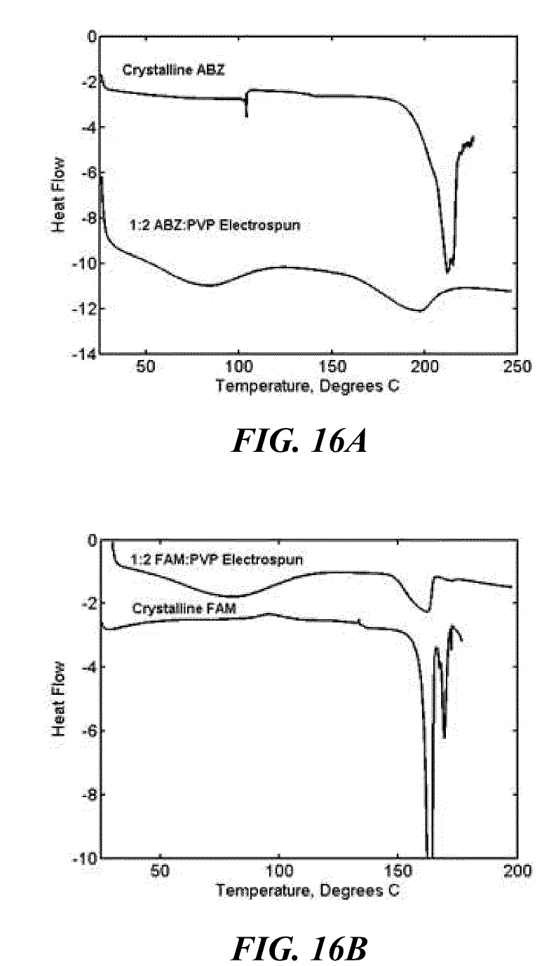

XRD and DSC were both used to examine the crystallinity of the API within the electrospun fibers. For 1:2 ABZ:PVP, the melting endotherm was found to be broad with an onset melting point of 165° C., as shown in FIG. 16A. This result indicates that the ABZ is crystalline in the fibers. The melting point is depressed from that of the crystalline ABZ as received, 190° C.

The first onset melting point for crystalline FAM as received is about 160° C. (FIG. 16B), and based on the DSC results for FAM there is a broad melting endotherm for the electrospun 1:2 FAM:PVP with an onset at 150° C. This melting point corresponds to polymorph B³⁸. There is a second melting endotherm for the crystalline material as received with on onset at 167° C. corresponding to polymorph A³⁸. This melting endotherm is also present for the 1:2 FAM:PVP electrospun material with an onset at 167° C. These results indicate that both the crystalline material as received and the FAM in the final electrospun fibers are mixtures of polymorphs A and B.

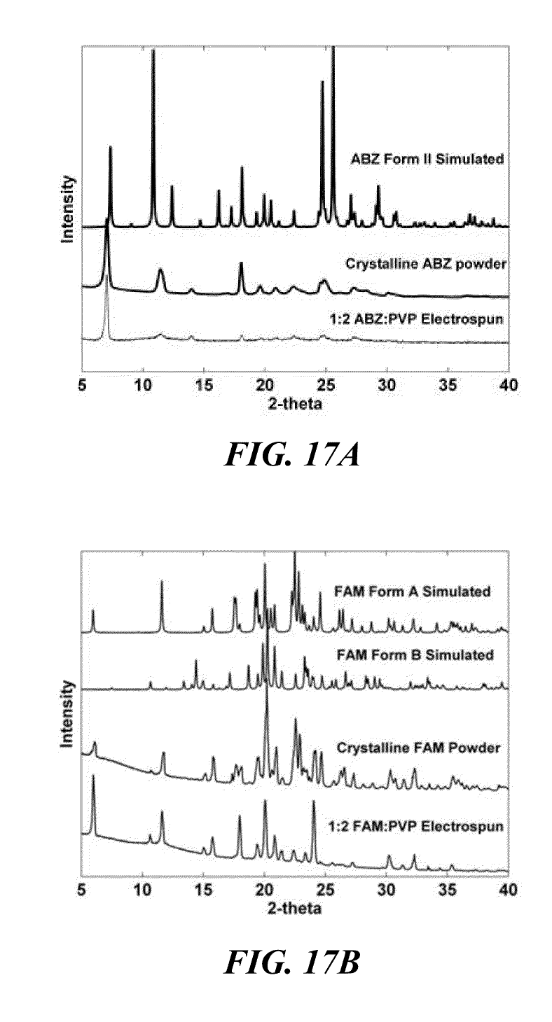

XRD powder patterns were used to determine polymorphism of the APIs following electrospinning. FIGS. 17A and 17B compare the experimental powder patterns to the calculated powder patterns from the Cambridge Structural Database. In FIG. 17A, a calculated XRD powder pattern is shown for crystalline ABZ form II³⁹, and experimental XRD powder patterns of crystalline ABZ as received and 1:2 ABZ:PVP electrospun are also shown. In FIG. 17B, calculated XRD powder patterns are shown for crystalline FAM forms A⁴⁰ and B⁴¹, and experimental XRD powder patterns of crystalline FAM as received and 1:2 FAM:PVP electrospun are also shown.

For ABZ, both the crystalline material as received and the 1:2 ABZ:PVP electrospun powder patterns show the same peaks as the calculated powder pattern for form II³⁹ (FIG. 17A). The polymorphism of the ABZ was not significantly affected by the electrospinning process. The powder patterns for the crystalline FAM as received and 1:2 FAM:PVP electrospun are mixtures of polymorphs A and B (FIG. 17B), as can be seen by comparing them to the calculated powder patterns from the Cambridge Structural Database for polymorphs A⁴ and B⁴¹ in the same graph. Though many peaks are overlapping, the presence of peaks at both 10.7 degrees, 2-theta and 11.7 degrees, 2-theta confirm the presence of both polymorphs. Differences in relative peak intensities can be attributed to the difference in sample preparation. The powder samples were flattened onto the zero background plate in a disordered manner, while the electrospun mat was laid onto the plate with all the fibers parallel to the flat plate.

Results—Loading:

The weight percent API in the electrospun fibers was determined using UV-vis spectroscopy. The average loading of ABZ in the fibers was 31 wt % and the average loading of FAM in the fibers was 26 wt %. Compared to the nominal API loading of 33 wt %, both cases showed lower loading than expected, and a probably reason for this is explained below.

Results—Dissolution:

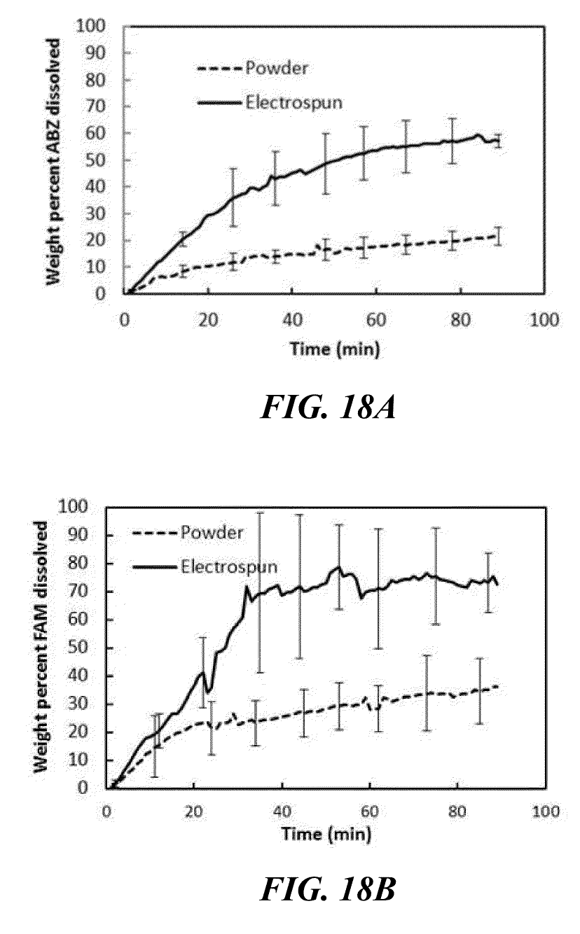

Tablets prepared from a powder mixture and tablets prepared from electrospun material were subjected to USP dissolution tests to compare the release behavior of API for the two preparation methods. All tablets tested had the same mass and were prepared using the same insertion depth, meaning that the surface area and volume of the tablets is the same for all tested. The dissolution curves for ABZ are shown in FIG. 18A, and results for FAM are shown in FIG. 18B. Compressed powder tablets are plotted as dashed lines, and compressed electrospun tablets are plotted as solid lines. The error bars indicate the standard deviation of an average of three data points. For both ABZ and FAM, the electrospun formulations showed marked improvement (more than twice the dissolution amount) over the compressed powder tablets. At 40 minutes, the fibrous compositions yield an improvement of about three times as much material dissolved. Initial dissolution rates for the fibrous compositions are also considerably higher.

Discussion:

Suspensions of crystalline particles of API were found to be spinnable using free-surface electrospinning, and fibers were produced having diameters of approximately 1-3 μm and retaining crystalline particles with sizes that significantly exceeded the fiber diameters. However, for the 1:2 FAM:PVP formulation in particular, the resulting API loading was slightly lower than 33 wt %.

In order to examine why the loading is lower than expected, calculations were carried out to evaluate the settling velocity, vₛ, as a function of the particle radius using the following relation:

$${v}_{s} = \frac{2}{9} \frac{( {ρ}_{p} - {ρ}_{f} )}{μ} {gR}^{2} \qquad ( 9 )$$

where ρ_{f} is the fluid density, ρₚ is the particle density, μ is the viscosity, g is the gravitational acceleration and R is the particle radius. The fluid density and viscosity used were the same as 8.6 wt % 1.3 MDa PVP in ethanol used in Experiment 1 above. The particle densities were taken from the Cambridge Structural Database and were 1.56 g/cm³ and 1.38 g/cm³ for FAM and ABZ, respectively. The velocity of Eq. 9 is based on Stoke's law and thus is for spherical particles. Though some particles in the experiment are more plate-shaped, spherical geometry was used to obtain a first-order approximation of the settling velocity.

From the settling velocity, the time required for a particle of a given radius to settle to the bottom of the electrospinning bath can be determined. The distance between the top of the fluid level when full and the lowest point of the wire rotation was measured to be about 0.8 cm. Since the particles are dispersed evenly within the suspension at the start of the experiment, it is assumed that an average particle must travel 0.4 cm, or half the depth of the bath.

Once the time required to settle is determined for a range of particle diameters, the smallest particle diameter that would settle out in about 1 hour, the duration of the electrospinning, was determined. For ABZ smallest particle is about 82.5 μm and for FAM it was found to be about 70.8 μm. The particle size distribution based on volume percent is known for these solutions from the Malvern results. It could then be calculated that about 0.1 vol % ABZ and about 4.5 vol % FAM would be expected to settle out during the duration of the electrospinning process. Converted to weight percent, the calculated settling amount would be about 0.14 wt % ABZ and 7.1 wt % FAM, which are of similar magnitude to the difference between the nominal and experimental API loading. These values are merely an estimate, due to the assumptions of spherical particles and the average distance traveled and the time, but they provide insight into the difference in the final API loading in the fibers for the two APIs chosen for this study. For this method to be applied to a large continuous process, a stirring mechanism in the bath or a surfactant may be used to keep the particles in the suspension.

The crystal size, the extent of particle distribution in the polymer mesh, and the crystalline morphology are important properties of the electrospun API/polymer mixture that may influence the dissolution of the APIs, and thus the effectiveness of a final pharmaceutical formulation. Understanding and controlling these properties may be beneficial for pharmaceutical manufacturing.

From both the particle size analyses of the spinning suspension and the SEM images, it was found that the crystals ranged in size from about 0.1 μm to about 100 μm, with a volume percent-based mean of approximately 10 μm. For ABZ in particular, sonication treatment prior to electrospinning decreased the measured particle size by breaking up aggregates. The crystals are relatively small, and thus are expected to enhance the dissolution rate through an increase in the surface area, as predicted by the Noyes-Whitney equation:

$$\frac{d m}{d t} = \frac{DA}{h} ( {C}_{sat} - C ) \qquad ( 10 )$$

where

$$\frac{d m}{d t}$$

is the dissolution rate, D is the diffusion coefficient, A is the surface area for diffusion, h is the diffusional path length, Cₛₐₜ is the solubility and C is the concentration in solution.

In order to take advantage of smaller crystal sizes, e.g., for enhancing the dissolution rate, it may be beneficial to keep the particles from aggregating. Using electrospinning, this can be done by trapping the particles by the small polymer fibers. The SEM images, e.g., FIGS. 15A-15D, show that the particles are present, retained by fibers, mostly non-agglomerated, and distributed in the fibrous mesh. Rapid carrier liquid evaporation following the dispersion using sonication during the electrospinning process aids in keeping the particles from agglomerating. Once in the dried solid form, the particles remain distributed in the mesh and retained by fibers until the polymer begins to dissolve during dissolution testing.

Further evidence that the APIs are well-dispersed within the fibers comes from the DSC results. The depression of the melting points of the APIs and the broadening of the melting endotherms indicate that the APIs are well-dispersed within the fibers and form a partially miscible blend with the polymer as the APIs melt during the temperature ramp of the DSC experiment. (See, Marsac, P. J.; Li, T.; Taylor, L. S. 2008. Estimation of Drug-Polymer Miscibility and Solubility in Amorphous Solid Dispersions Using Experimentally Determined Interaction Parameters. Pharm. Res. 26, 1, 139-151.)

As was observed, the dissolution rate of the API from compressed electrospun tablets is significantly higher than from compressed powder tablets. As the highly soluble polymer in the electrospun fibers dissolves, the API crystals are released as individual crystals and the exposed surface area is larger than that for agglomerates of API in the compressed powder tablets, resulting in increased dissolution rate.

All literature and similar material cited in this application, including, but not limited to, patents, patent applications, articles, books, treatises, and web pages, regardless of the format of such literature and similar materials, are expressly incorporated by reference in their entirety. In the event that one or more of the incorporated literature and similar materials differs from or contradicts this application, including but not limited to defined terms, term usage, described techniques, or the like, this application controls.

The section headings used herein are for organizational purposes only and are not to be construed as limiting the subject matter described in any way.

While the present teachings have been described in conjunction with various embodiments and examples, it is not intended that the present teachings be limited to such embodiments or examples. On the contrary, the present teachings encompass various alternatives, modifications, and equivalents, as will be appreciated by those of skill in the art.

The claims should not be read as limited to the described order or elements unless stated to that effect. It should be understood that various changes in form and detail may be made by one of ordinary skill in the art without departing from the spirit and scope of the appended claims. All embodiments that come within the spirit and scope of the following claims and equivalents thereto are claimed.

What is claimed is:

1. A composition, comprising:
a plurality of elongated polymeric fibers; and
a plurality of crystals comprising at least one pharmaceutically active ingredient, wherein at least a portion of the crystals are retained by one or more of the elongated polymeric fibers and at least some of the crystals that are retained have a first cross-sectional dimension that is greater than a second cross-sectional dimension of the fiber.

2. The composition of claim 1, wherein the polymeric fibers are biocompatible.

3. The composition of claim 1, wherein the polymeric fibers are biodegradable.

4. The composition of claim 1, wherein the composition forms a porous non-woven matrix.

5. The composition of claim 4, further comprising at least a portion of the crystals dispersed within the non-woven matrix.

6. The composition of claim 5, wherein at least some of the crystals dispersed within the non-woven matrix are aggregated.

7. The composition of claim 1, wherein the crystals are substantially of a same polymorph.

8. The composition of claim 1, wherein the crystals that are retained are encapsulated by a thin film of polymer.

9. The composition of claim 8, wherein the thin film of polymer is the same polymer used to form the elongated polymeric fibers.

10. The composition of claim 1, wherein the first cross-sectional dimension is at least about 2 times the second cross-sectional dimension.

11. The composition of claim 1, wherein the second cross-sectional dimension is less than about 10 microns.

12. The composition of claim 1, wherein the first cross-sectional dimension is an average cross-sectional dimension or a maximum cross-sectional dimension.

13. The composition of claim 12, wherein the second cross-sectional dimension is an average cross-sectional dimension or a maximum cross-sectional dimension.

14. The composition of claim 1 formed into a tablet and/or capsule.

15. The composition of claim 1 formed into a pad.

16. A method comprising:
providing a suspension comprising a carrier liquid, a polymeric binder dissolved in the carrier liquid, and a crystalline pharmaceutically active ingredient suspended in the carrier liquid; and
exposing the suspension to an electric field to produce at least one elongated fiber comprising at least a portion of the polymeric binder and at least some of the crystalline pharmaceutically active ingredient.

17. The method of claim 16, wherein the act of exposing comprises an electro spinning step.

18-25. (canceled)

26. A method comprising:
exposing a suspension comprising organic crystalline particles dispersed in a solution to an electric field such that at least one fiber retaining one or more of the organic crystalline particles is drawn from the suspension.

27-28. (canceled)

29. The method of claim 26, wherein the organic crystalline particles are characterized by a first cross-sectional dimension that is greater than a second cross-sectional dimension of the at least one fiber.

30. The method of claim 26, wherein the organic crystalline particles that are retained in the fiber are at least partially encapsulated by a polymer.

31-40. (canceled)
